(19) United States
(12) Patent Application Publication
(10) Pub. No.: US 2024/0049074 A1
(43) Pub. Date: Feb. 8, 2024

(54) NETWORK HANDLING OF PRIMARY SECONDARY CELL GROUP CELL (PSCELL) CHANGE

(71) Applicant: QUALCOMM Incorporated, San Diego, CA (US)

(72) Inventors: Shankar KRISHNAN, San Diego, CA (US); Rajeev KUMAR, San Diego, CA (US); Xipeng ZHU, San Diego, CA (US)

(21) Appl. No.: 18/365,345

(22) Filed: Aug. 4, 2023

Related U.S. Application Data
(60) Provisional application No. 63/370,717, filed on Aug. 8, 2022.

(51) Int. Cl. H04W 36/00; H04W 36/08

(52) U.S. Cl. CPC H04W 36/0079; H04W 36/08

(57) ABSTRACT

Methods, devices, and mechanisms for detecting and reporting successful secondary node and/or primary secondary cell group cell (PScell) changes are provided. In one example, a method of wireless communication performed by a first network unit comprises: transmitting, to a second network unit, an indication of a primary secondary cell group cell (PScell) change associated with a user equipment (UE); transmitting, based on the indication, a SPC configuration; and receiving a SPC report, wherein the SPC report is based on the SPC configuration and SPC information associated with the UE.

### CROSS-REFERENCE TO RELATED APPLICATIONS

The present application claims the benefit of U.S. Provisional Application No. 63/370,727 filed Aug. 8, 2022, the disclosure of which is hereby incorporated herein by reference in its entirety.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE). To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

When operating in a wireless communications system, a UE may move between coverage areas of multiple different base stations. The UE may report channel measurements. When the BS detects a degradation in channel quality based on the reported channel measurements and/or other channel information, the BS may initiate a handover of UE to another BS that can provide the UE with a better channel quality. In cases where radio signals of a neighboring base station, which may be referred to as a target base station, will provide an enhanced connection with a UE relative to a currently serving (or source) base station, the UE may be handed over from the source base station to the target base station. Such techniques may be referred to as handover procedures or mobility procedures, and help to provide continuous connectivity to a UE as it moves in a wireless communications system. In some systems, a UE may release an active connection with the source base station and establish a new connection with the target base station in response to a handover communication from the source base station. Enhanced techniques for performing handover may help to enhance the overall efficiency and reliability of a wireless communications system. Accordingly, improvements in mobility support are also desirable for NR.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes methods, systems, and devices for detecting and reporting successful primary secondary cell group cell (PScell) changes in a wireless communication scenario, according to aspects of the present disclosure. For example, a user equipment (UE) may be in communication with a network via two or more network nodes, including a primary or master node (MN) and at least one secondary node (SN). In some instances, channel conditions observed and reported by the UE may trigger or otherwise cause the network to perform a PScell change to reconfigure the UE with a different PScell and/or SN. The present disclosure describes mechanisms that allow for different types of nodes (e.g., MN, SN) to configure a UE for a PScell change and for successful PScell change (SPC) reporting. In some aspects, a network node may be configured to generate or determine a SPC reporting configuration and communicate the configuration with the UE. In some aspects, the node generating the SPC reporting configuration may be a MN. In another aspect, the node may be a SN. The call flow or protocol for configuring the UE for SPC determination and reporting may be based on the type of node determining the SPC reporting configuration. In another aspect, a UE may be configured to detect a SCG failure during or after the PScell change. The present disclosure provides schemes and mechanisms for the UE to detect, store, and/or report SCG failure-related information to report to the network. Based on the SPC and/or SCG failure reporting from the UE, one or more network nodes may perform network optimizations that may reduce the chance of MCG and/or SCG failures in the future.

According to one aspect of the present disclosure, a method of wireless communication performed by a first network unit comprises: transmitting, to a second network unit, an indication of a primary secondary cell group cell (PScell) change associated with a user equipment (UE); transmitting, based on the indication, a SPC report configuration; and receiving a SPC report, wherein the SPC report is based on the SPC report configuration and SPC information associated with the UE.

According to another aspect of the present disclosure, a method of wireless communication performed by a first master node comprises: receiving, from a second master node, a handover (HO) request; transmitting, to a first secondary node (SN), a primary secondary cell group cell (PScell) change request; receiving, from a user equipment (UE), a first message indicating successful HO information is available and successful PScell change information is available; transmitting, to the UE based on the first message, at least one request for the successful HO information and the successful PScell change information; and receiving, from the UE based on the at least one request, a successful HO report indicating the successful HO information and a SPC report indicating the successful PScell change information.

According to another aspect of the present disclosure, a method of wireless communication performed by a user equipment (UE) comprises: receiving, from a secondary node (SN), an SN modification indication; receiving, from the SN based on the SN modification indication, a successful primary secondary cell group cell (PScell) change report configuration; and transmitting a SPC report, wherein the SPC report is based on the SPC report configuration and PScell change information associated with the UE.

According to another aspect of the present disclosure, a method of wireless communication performed by a user equipment (UE) comprises: receiving, from a network node, a reconfiguration message for a PSCell change; detecting, based on the reconfiguration message, a PSCell change failure ; transmitting, to the network node based on the detecting the failure, a secondary cell group (SCG) failure report indicating SCG failure-related information; and transmitting, to the network node after the transmitting the SCG report, a further SCG failure report indicating additional SCG failure-related information.

According to another aspect of the present disclosure, a first network unit comprises: a memory device; a transceiver; and a processor in communication with the processor and the transceiver, wherein the first network unit is configured to: transmit, to a second network unit, an indication of a primary secondary cell group cell (PScell) change associated with a user equipment (UE); transmit, based on the indication, a SPC report configuration; and receive a SPC report, wherein the SPC report is based on the SPC report configuration and successful PScell change information associated with the UE.

According to another aspect of the present disclosure, a first master node comprises: a memory device; a transceiver; and a processor in communication with the processor and the transceiver, wherein the first master node is configured to: receive, from a second master node, a handover (HO) request; transmit, to a first secondary node (SN), a primary secondary cell group cell (PScell) change request; receive, from a user equipment (UE), a first message indicating successful HO information is available and successful PScell change information is available; transmit, to the UE based on the first message, at least one request for the successful HO information and the successful PScell change information; and receive, from the UE based on the at least one request, a successful HO report indicating the successful HO information and a SPC report indicating the successful PScell change information.

According to another aspect of the present disclosure, a user equipment (UE) comprises: a memory device; a transceiver; and a processor in communication with the processor and the transceiver, wherein the UE is configured to: receive, from a secondary node (SN), an SN modification indication; receive, from the SN based on the SN modification indication, a successful primary secondary cell group cell (PScell) change report configuration; and transmit a SPC report, wherein the SPC report is based on the SPC report configuration and PScell change information associated with the UE.

According to another aspect of the present disclosure, a user equipment (UE) comprises: a memory device; a transceiver; and a processor in communication with the processor and the transceiver, wherein the UE is configured to: receive, from a network node, a reconfiguration message for a PSCell change; detect, based on the reconfiguration message, a PSCell change failure; transmit, to the network node based on the detecting the failure, a secondary cell group (SCG) failure report indicating SCG failure-related information; and transmit, to the network node after the transmitting the SCG report, a further SCG failure report indicating additional SCG failure-related information.

According to another aspect of the present disclosure, a non-transitory, computer-readable medium having program code recorded thereon, wherein the program code comprises instructions executable by a processor of a first network unit, wherein the instructions comprise code for causing the first network unit to: transmit, to a second network unit, an indication of a primary secondary cell group cell (PScell) change associated with a user equipment (UE); transmit, based on the indication, a SPC report configuration; and receive a SPC report, wherein the SPC report is based on the SPC report configuration and successful PScell change information associated with the UE.

According to another aspect of the present disclosure, a non-transitory, computer-readable medium having program code recorded thereon, wherein the program code comprises instructions executable by a processor of a first master node, wherein the instructions comprise code for causing the first master node to: receive, from a second master node, a handover (HO) request; transmit, to a first secondary node (SN), a primary secondary cell group cell (PScell) change request; receive, from a user equipment (UE), a first message indicating successful HO information is available and successful PScell change information is available; transmit, to the UE based on the first message, at least one request for the successful HO information and the successful PScell change information; and receive, from the UE based on the at least one request, a successful HO report indicating the successful HO information and a SPC report indicating the successful PScell change information.

According to another aspect of the present disclosure, a non-transitory, computer-readable medium having program code recorded thereon, wherein the program code comprises instructions executable by a processor of a user equipment (UE), wherein the instructions comprise code for causing the UE to: receive, from a secondary node (SN), an SN modification indication; receive, from the SN based on the SN modification indication, a successful primary secondary cell group cell (PScell) change report configuration; and transmit a SPC report, wherein the SPC report is based on the SPC report configuration and PScell change information associated with the UE.

According to another aspect of the present disclosure, a non-transitory, computer-readable medium having program code recorded thereon, wherein the program code comprises instructions executable by a processor of a user equipment (UE), wherein the instructions comprise code for causing the UE to: receive, from a network node, a reconfiguration message for a PSCell change; detect, based on the reconfiguration message, a PSCell change failure ; transmit, to the network node based on the code for causing the UE to detect the failure, a secondary cell group (SCG) failure report indicating SCG failure-related information; and transmit, to the network node after the code for causing the UE to transmit the SCG report, a further SCG failure report indicating additional SCG failure-related information.

According to another aspect of the present disclosure, a first network unit comprises: means for transmitting, to a second network unit, an indication of a primary secondary cell group cell (PScell) change associated with a user equipment (UE); means for transmitting, based on the indication, a SPC report configuration; and means for receiving a SPC report, wherein the SPC report is based on the SPC report configuration and successful PScell change information associated with the UE.

According to another aspect of the present disclosure, a first master node comprises: means for receiving, from a second master node, a handover (HO) request; means for transmitting, to a first secondary node (SN), a primary secondary cell group cell (PScell) change request; means for receiving, from a user equipment (UE), a first message indicating successful HO information is available and successful PScell change information is available; means for transmitting, to the UE based on the first message, at least one request for the successful HO information and the successful PScell change information; and means for receiving, from the UE based on the at least one request, a successful HO report indicating the successful HO information and a SPC report indicating the successful PScell change information.

According to another aspect of the present disclosure, a user equipment (UE) comprises: means for receiving, from a secondary node (SN), an SN modification indication; means for receiving, from the SN based on the SN modification indication, a successful primary secondary cell group cell (PScell) change report configuration; and means for transmitting a SPC report, wherein the SPC report is based on the SPC report configuration and PScell change information associated with the UE.

According to another aspect of the present disclosure, a user equipment (UE) comprises: means for receiving, from a network node, a reconfiguration message for a PSCell change; means for detecting, based on the reconfiguration message, a PSCell change failure ; means for transmitting, to the network node based on the means for detecting the failure, a secondary cell group (SCG) failure report indicating SCG failure-related information; and means for transmitting, to the network node after the means for transmitting the SCG report, a further SCG failure report indicating additional SCG failure-related information.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1A illustrates a wireless communication network according to some aspects of the present disclosure.

FIG. 1B is a diagram illustrating an example disaggregated base station architecture, according to some aspects of the present disclosure.

FIG. 2 illustrates a wireless communication network that provisions for user equipment reporting according to some aspects of the present disclosure.

FIG. 3 illustrates an example of a wireless communications system that supports a handover mechanism and a primary secondary cell group cell (PScell) change mechanism in wireless communications according to some aspects of the present disclosure.

FIG. 4 is a signaling diagram illustrating a PScell change process according to some aspects of the present disclosure.

FIG. 5 is a signaling diagram illustrating a PScell change and reporting process according to some aspects of the present disclosure.

FIG. 6 is a signaling diagram illustrating a PScell change and reporting process according to some aspects of the present disclosure.

FIG. 7 is a signaling diagram illustrating a PScell change and reporting process according to some aspects of the present disclosure.

FIG. 8 is a signaling diagram illustrating a PScell change and reporting process according to some aspects of the present disclosure.

FIG. 9 is a signaling diagram illustrating a PScell change and reporting process according to some aspects of the present disclosure.

FIG. 10 is a signaling diagram illustrating a PScell change and reporting process according to some aspects of the present disclosure.

FIG. 11 is a signaling diagram illustrating a PScell change and reporting process according to some aspects of the present disclosure.

FIG. 12 is a signaling diagram illustrating a PScell change and reporting process according to some aspects of the present disclosure.

FIG. 13 is a block diagram of a user equipment according to some aspects of the present disclosure.

FIG. 14 is a block diagram of an exemplary base station according to some aspects of the present disclosure.

FIG. 15 is a flow diagram of an example method for reporting successful PScell change information according to some aspects of the present disclosure.

FIG. 16 is a flow diagram of an example method for reporting successful PScell change information during a network handover procedure according to some aspects of the present disclosure.

FIG. 17 is a flow diagram of an example method for reporting successful PScell change information according to some aspects of the present disclosure.

FIG. 18 is a flow diagram of an example method for reporting successful PScell change information according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1 M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

A wireless channel between the network (e.g., a BS) and a UE may vary over time. The BS may configure a set of beams for the UE, which at any point of time may use one or two serving beams to receive DL transmissions from or transmit UL transmissions to the BS. The BS and the UE may keep track of the serving beam(s) as well as candidate beams. For example, the UE may perform one or more measurements of one or more reference signals configured for the UE and may include the one or more measurements in a channel state information (CSI) report. If a serving beam fails, the BS may reconfigure the UE to use of the candidate beams. Candidate beams may be regularly updated because the channel quality between the BS and the UE may change over time. It may be desirable for the UE update the serving beam(s) according to the channel state. The UE may report the link quality of the serving beam(s) and the candidate beams in a CSI report to the BS, and the BS may process the CSI report and determine whether the UE's serving beam(s) or candidate beam(s) should be reconfigured. If the quality of a beam falls below a threshold, the BS may reconfigure a beam the UE's serving beam(s) or candidate beam(s). The BS may configure the threshold. Based on the determination, the BS may transmit a command to reconfigure the UE's serving beam(s) and/or candidate beam(s) in response to the CSI report.

The BS may configure the UE to periodically report the CSI report to the BS. The CSI report may include, for example, channel quality information (CQI) and/or reference signal received power (RSRP). CQI is an indicator carrying information on the quality of a communication channel. The BS may use the CQI to assist in downlink (DL) scheduling. The BS may use the RSRP to manage beams in multi-beam operations. The UE may perform different combinations of measurements for inclusion in the CSI report. Accordingly, the UE may transmit a CSI report including the CQI but not the RSRP, a CSI report including the RSRP but not the CQI, and/or a CSI report including both the CQI and the RSRP.

Future cellular networks need to support data-hungry applications with enhanced data rates possibly via cell densification. In addition to providing high data rates, it may be equally important to provide reliable handover mechanisms as this directly impacts on the perceived quality of experience for the end-user. In 5G NR, reliable handover mechanisms that provides high data-rates for moderate-to-high speed users in urban environments remains a challenge. In some instances, network operators may deploy base stations and turn them on and off in a coordinated manner to save energy. As a result, radio channel conditions may change dramatically for the mobile users and so the neighboring cell list changes rapidly.

In some aspects, a UE may be configured for dual connectivity with two or more network nodes and on two or more cells. The UE may receive service from a master node (MN) for a master cell group (MCG), and from a secondary node (SN) for a secondary cell group (SCG). In some aspects, the UE may communicate with network via a primary SCG cell, referred to as a PScell. In some instances, the channel condition reporting from the UE may result in the network determining to change the PScell and/or the SN facilitating the PScell communications. The network nodes may coordinate the PScell change, and may configure the UE to detect and report a successful PScell change (SPC). Because multiple network nodes are communicating with the UE, it may be advantageous to define, configure, or otherwise specify the roles and responsibilities of each node in configuring the UE to report PScell change information, as well as the call flow or signaling protocol for facilitating PScell changes.

The present disclosure describes systems, devices, and methods for PScell changes with SPC reporting. For example, a network node may be configured to generate or determine a SPC reporting configuration and communicate the configuration with the UE. In some aspects, the node generating the SPC reporting configuration may be the master node (MN). In another aspect, the node may be a secondary node (SN). The call flow or protocol for configuring the UE for SPC determination and reporting may be based on the type of node determining the SPC reporting configuration. In another aspect, a UE may be configured to detect a SCG failure during or after the PScell change. The present disclosure provides schemes and mechanisms for the UE to detect, store, and/or report SCG failure-related information to report to the network. Based on the SPC and/or SCG failure reporting from the UE, one or more network nodes may perform network optimizations that may reduce the chance of MCG and/or SCG failures in the future.

Aspects of the present disclosure provide several benefits and advantages. For example, the aspects of the present disclosure provide efficient architectures and protocols for configuring UEs to detect and report PScell conditions and/or successful changes, and to perform network optimizations based on the reports. The aspects of the present disclosure also provide for advantageous SCG failure reporting such that the network may be provided with additional useful SCG failure-related information to perform the network optimizations. Further, the present disclosure describes methods and procedures for correlating SCG failure information and SPC information for performing network optimizations, with or without UE context.

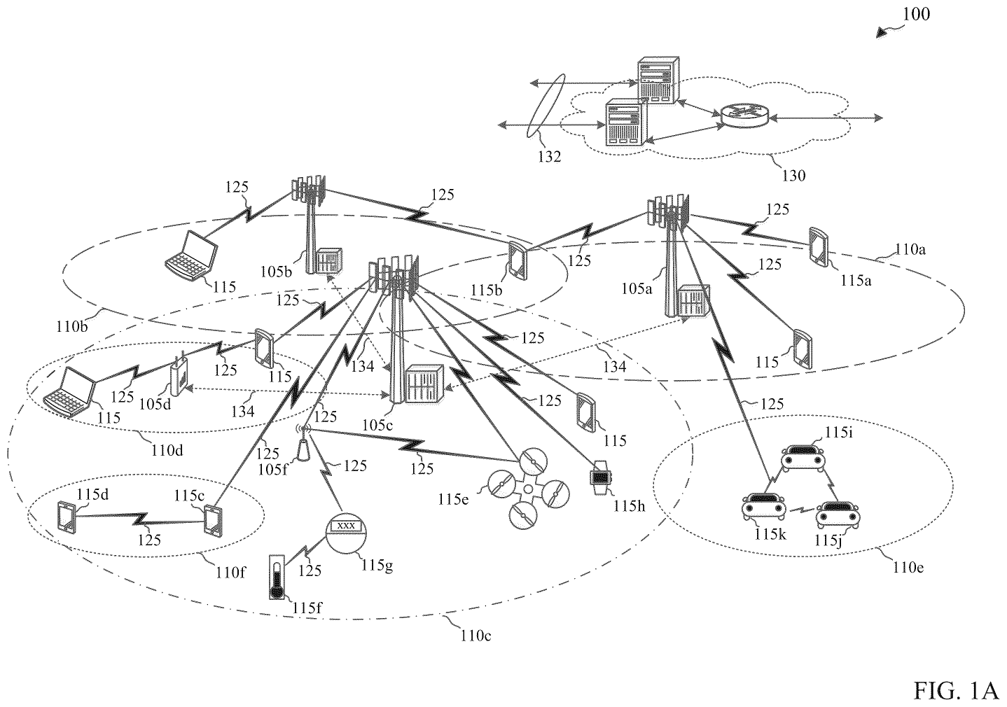

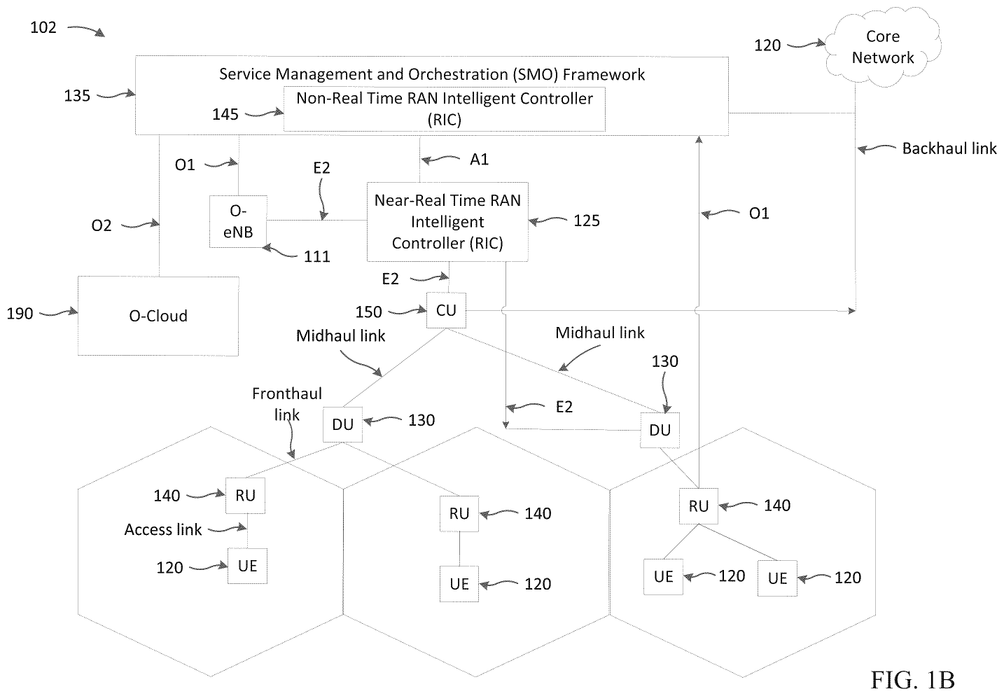

FIG. 1A illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. For example, each BS 105 may provide communication coverage for a respective geographic coverage area 110. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1A, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells. In the example shown in FIG. 1A, the BSs 105a, 105b and 105c are examples of macro BSs for the coverage areas 110a, 110b and 110c, respectively. The BSs 105d is an example of a pico BS or a femto BS for the coverage area 110d.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. In one aspects, UEs 115c and 115d are in communication with one another through sidelink transmissions between the UEs 115c and 115d in a coverage area 110f. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles in coverage area 110e that are equipped with wireless communication devices configured for communication that access the network 100. A UE 115 may be able to communicate with any type of the BSs, whether macro BS, small cell, or the like. In FIG. 1A, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

At least some of the network devices, such as a base station 105, may include subcomponents such as an access network entity, which may be an example of the ANC or centralized unit (CU). Each access network entity may communicate with UEs 115 through a number of other access network transmission entities, which may be referred to as a radio head, a smart radio head, a transmission/reception point (TRP), or a distributed unit (DU). In some configurations, various functions of each access network entity or base station 105 may be distributed across various network devices (e.g., radio heads and access network controllers) or consolidated into a single network device (e.g., a base station 105). For example, a CU may control two or more DUs, which may each be associated with a different cell.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (e.g., PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection (ED) or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT, a category 2 (CAT2) LBT, or a category 1 (CAT1) LBT. A CAT1 LBT is referred to a no LBT mode, where no LBT is to be performed prior to a transmission. A CAT2 LBT refers to an LBT without a random backoff period. For instance, a transmitting node may determine a channel measurement in a time interval and determine whether the channel is available or not based on a comparison of the channel measurement against a ED threshold. A CAT4 LBT refers to an LBT with a random backoff and a variable contention window (CW). For instance, a transmitting node may draw a random number and backoff for a duration based on the drawn random number in a certain time unit.

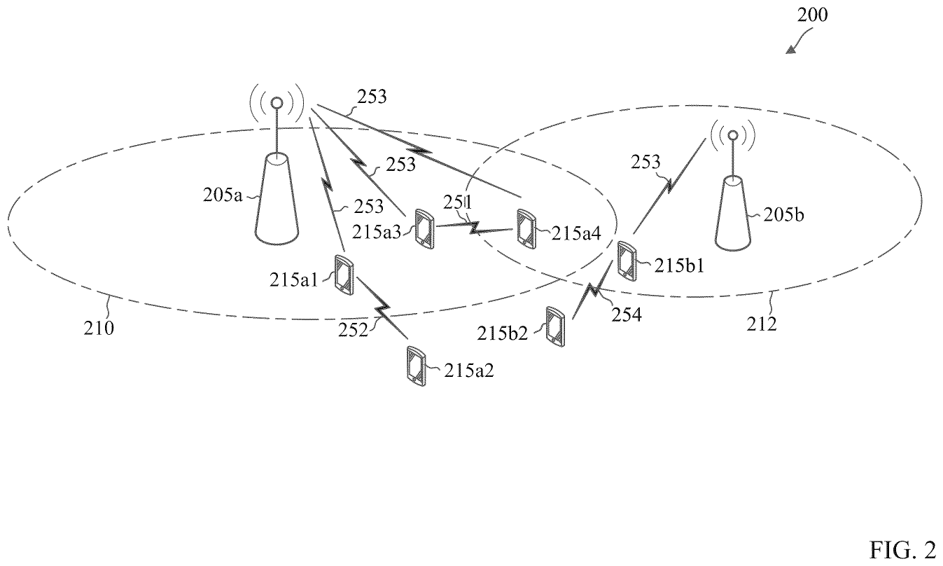

In some aspects, the network 100 may support sidelink communication among the UEs 115 over a shared radio frequency band (e.g., in a shared spectrum or an unlicensed spectrum). In some aspects, the UEs 115 may communicate with each other over a 2.4 GHz unlicensed band, which may be shared by multiple network operating entities using various radio access technologies (RATs) such as NR-U, WiFi, and/or licensed-assisted access (LAA) as shown in FIG. 2.

FIG. 1B shows a diagram illustrating an example disaggregated base station 102 architecture. The disaggregated base station 102 architecture may include one or more central units (CUs) 150 that can communicate directly with a core network 104 via a backhaul link, or indirectly with the core network 104 through one or more disaggregated base station units (such as a Near-Real Time (Near-RT) RAN Intelligent Controller (RIC) 125 via an E2 link, or a Non-Real Time (Non-RT) RIC 145 associated with a Service Management and Orchestration (SMO) Framework 135, or both). A CU 150 may communicate with one or more distributed units (DUs) 130 via respective midhaul links, such as an F1 interface. The DUs 130 may communicate with one or more radio units (RUs) 140 via respective fronthaul links. The RUs 140 may communicate with respective UEs 120 via one or more radio frequency (RF) access links. In some implementations, the UE 120 may be simultaneously served by multiple RUs 140.

Each of the units, i.e., the CUs 150, the DUs 130, the RUs 140, as well as the Near-RT RICs 125, the Non-RT RICs 145 and the SMO Framework 135, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 150 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 150. The CU 150 may be configured to handle user plane functionality (i.e., Central Unit—User Plane (CU-UP)), control plane functionality (i.e., Central Unit—Control Plane (CU-CP)), or a combination thereof. In some implementations, the CU 150 can be logically split into one or more CU-UP units and one or more CU-CP units. The CU-UP unit can communicate bidirectionally with the CU-CP unit via an interface, such as the E1 interface when implemented in an O-RAN configuration. The CU 150 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 130 may further host one or more low PHY layers. Each layer (or module) can be implemented with an interface configured to communicate signals with other layers (and modules) hosted by the DU 130, or with the control functions hosted by the CU 150.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs. In some implementations, real-time and non-real-time aspects of control and user plane communication with the RU(s) 140 can be controlled by the corresponding DU 130. In some scenarios, this configuration can enable the DU(s) 130 and the CU 150 to be implemented in a cloud-based RAN architecture, such as a vRAN architecture.

The SMO Framework 135 may be configured to support RAN deployment and provisioning of non-virtualized and virtualized network elements. For non-virtualized network elements, the SMO Framework 135 may be configured to support the deployment of dedicated physical resources for RAN coverage requirements which may be managed via an operations and maintenance interface (such as an O1 interface). For virtualized network elements, the SMO Framework 135 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 150, DUs 130, RUs 140 and Near-RT RICs 125. In some implementations, the SMO Framework 135 can communicate with a hardware aspect of a 4G RAN, such as an open eNB (O-eNB) 111, via an O1 interface. Additionally, in some implementations, the SMO Framework 135 can communicate directly with one or more RUs 140 via an O1 interface. The SMO Framework 135 also may include a Non-RT RIC 145 configured to support functionality of the SMO Framework 135.

The Non-RT RIC 145 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 145 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 150, one or more DUs 130, or both, as well as an O-eNB, with the Near-RT RIC 125.

In some implementations, to generate AI/ML models to be deployed in the Near-RT RIC 125, the Non-RT RIC 145 may receive parameters or external enrichment information from external servers. Such information may be utilized by the Near-RT RIC 125 and may be received at the SMO Framework 135 or the Non-RT RIC 145 from non-network data sources or from network functions. In some examples, the Non-RT RIC 145 or the Near-RT RIC 125 may be configured to tune RAN behavior or performance. For example, the Non-RT RIC 145 may monitor long-term trends and patterns for performance and employ AI/ML models to perform corrective actions through the SMO Framework 135 (such as reconfiguration via O1) or via creation of RAN management policies (such as A1 policies).

FIG. 2 illustrates a wireless communication network 200 that provisions for user equipment reporting according to some aspects of the present disclosure. The network 200 may correspond to a portion of the network 100. FIG. 2 illustrates two BSs 205 (shown as 205a and 205b) and six UEs 215 (shown as 215a1, 215a2, 215a3, 215a4, 215b1, and 215b2) for purposes of simplicity of discussion, though it will be recognized that embodiments of the present disclosure may scale to any suitable number of UEs 215 (e.g., the about 2, 3, 4, 5, 7 or more) and/or BSs 205 (e.g., the about 1, 3 or more). The BS 205 and the UEs 215 may be similar to the BSs 105 and the UEs 115, respectively. The BSs 205 and the UEs 215 may share the same radio frequency band for communications. In some instances, the radio frequency band may be a 2.4 GHz unlicensed band, a 5 GHz unlicensed band, or a 6 GHz unlicensed band. In general, the shared radio frequency band may be at any suitable frequency.

The BS 205a and the UEs 215a1-215a4 may be operated by a first network operating entity. The BS 205b and the UEs 215b1-215b2 may be operated by a second network operating entity. In some aspects, the first network operating entity may utilize a same RAT as the second network operating entity. For instance, the BS 205a and the UEs 215a1-215a4 of the first network operating entity and the BS 205b and the UEs 215b1-215b2 of the second network operating entity are NR-U devices. In some other aspects, the first network operating entity may utilize a different RAT than the second network operating entity. For instance, the BS 205a and the UEs 215a1-215a4 of the first network operating entity may utilize NR-U technology while the BS 205b and the UEs 215b1-215b2 of the second network operating entity may utilize WiFi or LAA technology.

In the network 200, some of the UEs 215a1-215a4 may communicate with each other in peer-to-peer communications. For example, the UE 215a1 may communicate with the UE 215a2 over a sidelink 252, the UE 215a3 may communicate with the UE 215a4 over another sidelink 251, and the UE 215b1 may communicate with the UE 215b2 over yet another sidelink 254. The sidelinks 251, 252, and 254 are unicast bidirectional links. Some of the UEs 215 may also communicate with the BS 205a or the BS 205b in a UL direction and/or a DL direction via communication links 253. For instance, the UE 215a1, 215a3, and 215a4 are within a coverage area 210 of the BS 205a, and thus may be in communication with the BS 205a. The UE 215a2 is outside the coverage area 210, and thus may not be in direct communication with the BS 205a. In some instances, the UE 215a1 may operate as a relay for the UE 215a2 to reach the BS 205a. Similarly, the UE 215b1 is within a coverage area 212 of the BS 205b, and thus may be in communication with the BS 205b and may operate as a relay for the UE 215b2 to reach the BS 205b. In some aspects, some of the UEs 215 are associated with vehicles (e.g., similar to the UEs 115i-k) and the communications over the sidelinks 251, 252, and 254 may be C-V2X communications. C-V2X communications may refer to communications between vehicles and any other wireless communication devices in a cellular network.

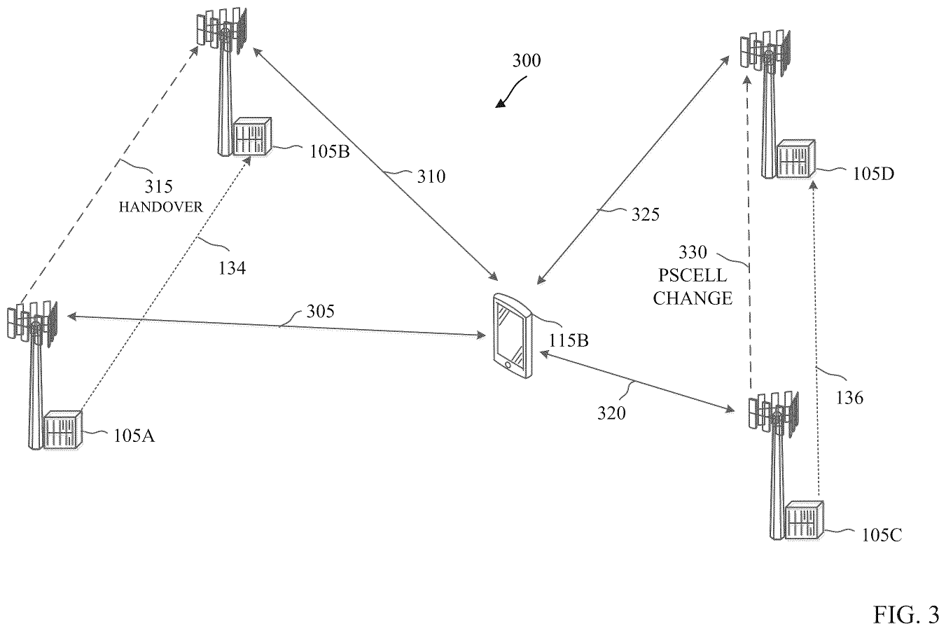

FIG. 3 illustrates an example of a wireless communications system 300 that supports a handover mechanism and a primary secondary cell group cell (PScell) change in wireless communications according to some aspects of the present disclosure. In some examples, wireless communications system 300 may implement aspects of wireless communications system 100. In some examples, wireless communications system 300 may implement aspects of wireless communications system 100. The wireless communications system 300 may include a first base station 105A, a second base station 105B, a third base station 105C, a fourth base station 105D, and UE 115B, which may be examples of a base station 105 and a UE 115, as described with reference to FIG. 1A. In some aspects, the BSs 105 may be referred to as network nodes.

First base station 105A may be a source base station 105 and the second base station 105B may be a target base station 105 in a handover 315 of the UE 115B from the first base station 105A to the second base station 105B. First base station 105A and second base station 105B may be in communication with each other, such as via backhaul link 134 (e.g., via an X2, Xn, or other interface), which may be a wired or wireless interface. While the example of FIG. 3 shows the first base station 105A in direct communication with the second base station 105B, in other cases the communication may be indirect, such as via a core network (e.g., core network 130 or FIG. 1). In this example, the UE 115B and the first base station 105A may establish a first connection 305. In the event that a handover is triggered, the UE 115B may establish a second connection 310 with the second base station 105B.

The third base station 105B may be a source base station 105 for a secondary cell and the fourth base station 105D may be a target base station 105 for the secondary cell in a PSCell change 330 of the UE 115B from the third base station 105C to the fourth base station 105D. Third base station 105C and fourth base station 105D may be in communication with each other, such as via backhaul link 136 (e.g., via an X2, Xn, or other interface), which may be a wired or wireless interface. While the example of FIG. 3 shows the third base station 105C in direct communication with the fourth base station 105D, in other cases the communication may be indirect, such as via a core network (e.g., core network 130 or FIG. 1). In this example, the UE 115B and the third base station 105C may establish a first PScell connection 320. In the event that a PScell change is triggered, the UE 115B may establish a second connection 325 with the fourth base station 105D. Various techniques as discussed herein provide for efficient handovers and PScell changes including mechanisms for initiating, configuring, and reporting PScell changes.

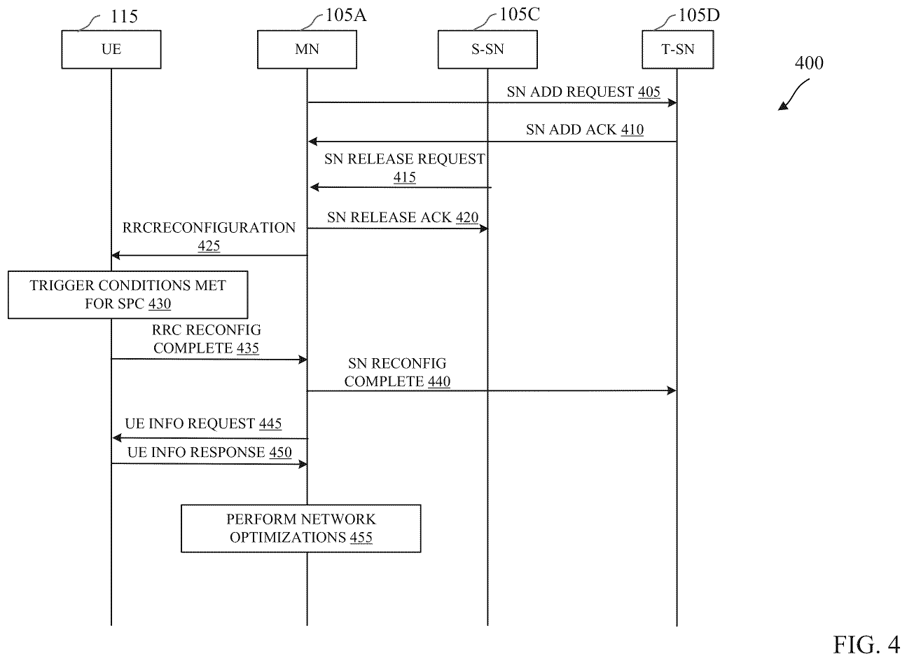

FIG. 4 is a signaling diagram illustrating a PScell change procedure 400 facilitated or otherwise controlled by a master node (MN) according to some aspects of the present disclosure. The PScell change procedure 400 may include a master node (MN) 105A, a source secondary node (S-SN) 105C, a target SN (T-SN) 105D, a UE 115, which may be examples of the corresponding devices described with reference to FIGS. 1A- 2. In some examples, the PScell change procedure 400 may implement aspects of the wireless communications system 100 and 200. For example, the MN 105A, the S-SN 105C, the T-SN 105D, and the UE 115, may support a PScell change procedure in which the MN configures the UE 115 to determine a successful PScell change and/or for PScell change reporting. As illustrated, the PScell change procedure 400 includes a number of enumerated steps, but embodiments of the PScell change procedure 400 may include additional steps before, after, and in between the enumerated steps. In some embodiments, one or more of the enumerated steps may be omitted or performed in a different order. In the following description of the PScell change procedure 400, the operations between the MN 105A, S-SN 105C, the T-SN 105D, and/or the UE 115 may be transmitted in a different order or at different times than the exemplary order shown. Certain operations may also be left out of the PScell change procedure 400, or other operations may be added to the PScell change procedure 400.

At step 405, a master node (MN) 105A transmits a secondary node (SN) addition request to a target SN (T-SN) 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the MN may transmit the SN addition request based on one or more reports and/or measurements obtained by the UE 115. In this regard, the UE 115 may obtain one or more channel measurements of a primary secondary cell group cell (PScell) facilitated by the source secondary node (S-SN) 105C. The UE 115 may transmit, to the MN 105A, S-SN 105C, and/or any other network node or device, a report indicating the channel measurements. For example, the UE 115 may transmit, to the MN 105A and/or to the S-SN 105C, a channel state information (CSI) report based on the channel measurements. A network node, such as the MN 105A, may determine to perform a PScell change based on the report.

At step 410, the T-SN 105D transmits, to the MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information.

At step 415, the MN 105A transmits, to the S-SN 105C, a SN release request requesting that the S-SN 105C release or discontinue communications with the UE 115. In some aspects, the SN release request may comprise an Xn message.

At step 420, the S-SN 105C transmits, to the MN 105A, a SN release request acknowledgement based on the SN release request. In some aspects, the SN release request acknowledgement may comprise an Xn message.

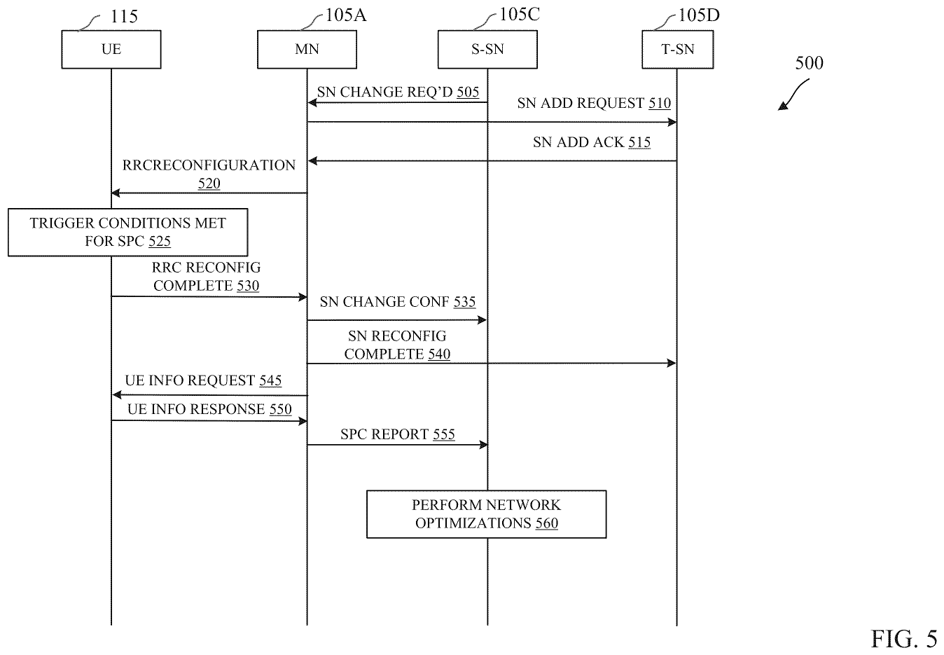

At step 425, the MN 105A transmits, to the UE 115, a RRCReconfiguration message. The RRCReconfiguration message may comprise or indicate a successful PScell change (SPC) configuration. In some aspects, the SPC configuration may comprise a SPC-Config. In some aspects, the SPC-Config may include or indicate information for the PScell change. For example, the SPC configuration may indicate one or more trigger events and/or conditions to determine whether the PScell change is successful. In some aspects, the SPC configuration may include or indicate one or more timer values or other thresholds that the UE 115 may use to determine whether the PScell change is successful. For example, the SPC configuration may include at least one of a T304 threshold, a T310 threshold, and/or a T312 threshold. In the illustrated example, the MN 105A may configure the SPC configuration autonomously. However, in other examples, (e.g., as illustrated in FIG. 5), the SPC configuration may be configured and/or determined by one or more other network nodes, such as the S-SN 105C and/or the T-SN 105D.

At step 430, the UE 115 determines that one or more trigger conditions have been met for the PScell change based on the SPC configuration transmitted at step 425. In some aspects, the conditions may be based on timer values or thresholds indicated in the SPC configuration. For example, the UE 115 may determine that the PScell change is successful based on one or more of a T304 threshold, a T310 threshold, and/or a T312 threshold.

At step 435, the UE 115 transmits, to the MN 105A based on the SPC configuration and the determination of step 430, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the MN 105A indicating that the successful PScell change information is available. In other aspects, the successful PScell change information may be carried and/or indicated in a RRC message and/or a media access control-control element (MAC-CE).

At step 440, the MN 105A transmits, to the T-SN 105D, a SN Reconfiguration complete message. In some aspects, the SN Reconfiguration complete message includes transmitting an Xn message including or indicating the SN Reconfiguration complete message.

At step 445, the MN 105A transmits, to the UE 115 based on the indication that PScell change information is available, an information request. In some aspects, the information request may include a UEInformationRequest message including or indicating a SPC report request. In some aspects, the UEInformationRequest message may comprise a RRC message or IE.

At step 450, the UE 115 transmits, to the MN 105A, a UE information response or report based on the information request transmitted at step 440. In some aspects, the UE information response includes a UEInformationResponse message including or indicating a SPC report. In some aspects, the SPC report may comprise information associated with the PScell change. For example, the SPC report may indicate one or more conditional events or triggers detected by the UE that indicate a successful PScell change. In some aspects, the UEInformationResponse message may comprise a RRC message or IE.

At step 455, based on the SPC report, the MN 105A performs one or more network optimizations. For example, in some aspects, the MN 105A may update one or more timer thresholds associated with radio link monitoring (RLM) and/or beam failure detection (BFD) of a MCG and/or SCG. In another aspect, the MN 105A may detect near failure scenarios during a successful PScell change and/or a successful handover (HO).

FIG. 5 is a signaling diagram illustrating a PScell change procedure 500 facilitated, initiated, and/or otherwise controlled by a SN according to some aspects of the present disclosure. The PScell change procedure 500 may include a MN 105A, a S-SN 105C, a T-SN 105D, a UE 115, which may be examples of the corresponding devices described with reference to FIGS. 1A-2. In some examples, the PScell change procedure 500 may implement aspects of the wireless communications system 100 and 200. For example, the MN 105A, the S-SN 105C, the T-SN 105D, and the UE 115, may support a PScell change procedure in which the SN initiates a PScell change and is at least partially involved in the configuration of the UE 115 to determine a successful PScell change and/or for PScell change reporting. As illustrated, the PScell change procedure 500 includes a number of enumerated steps, but embodiments of the PScell change procedure 500 may include additional steps before, after, and in between the enumerated steps. In some embodiments, one or more of the enumerated steps may be omitted or performed in a different order. In the following description of the PScell change procedure 500, the operations between the MN 105A, S-SN 105C, the T-SN 105D, and/or the UE 115 may be transmitted in a different order or at different times than the exemplary order shown. Certain operations may also be left out of the PScell change procedure 500, or other operations may be added to the PScell change procedure 500.

At step 505, a S-SN 105C transmits, and a MN 105A receives, a SN change required message causing the MN 105A to proceed with an SN addition, release, or other SN modification. In another aspect, the SN change required message may include or indicate one or more SPC configuration parameters. For example, the SN change required message may comprise a first portion of the SPC configuration. The S-SN 105C may determine and indicate in the SN change required message, at least one timer value or threshold. For example, the S-SN 105C may determine and indicate in the SN change required message at least one of a T310 timer value or threshold, and/or a T312 timer value or threshold.

At step 510, a MN 105A transmits, based on the SN change required message received from the S-SN 105C, a SN addition request to a T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the MN may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the MN 105A, S-SN 105C, and/or any other network node or device, a report indicating the channel measurements. For example, the UE 115 may transmit, to the MN 105A and/or to the S-SN 105C, a channel state information (CSI) report based on the channel measurements. A network node, such as the MN 105A, may determine to perform a PScell change based on the report.

At step 515, the T-SN 105D transmits, to the MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information. In some aspects, the SN addition acknowledge message may include one or more SPC configuration parameters. In this regard, the PSC configuration may include a second portion of a SPC configuration. For example, in some aspects, the SN addition request acknowledgement message may include or indicate a T304 time value or threshold.

At step 520, the MN 105A transmits, to the UE 115, a RRCReconfiguration message. The RRCReconfiguration message may comprise or indicate SPC configuration. In some aspects, the SPC configuration may comprise a SPC-Config. In some aspects, the SPC-Config may include or indicate information for the PScell change. For example, the SPC configuration may indicate a combination of SPC configuration parameters determined by the S-SN 105C and/or the T-SN 105D and indicated by the SN change required message transmitted at step 505 and/or the SN addition request acknowledgement message transmitted at step 515. In another aspect, the MN 105A may determine one or more additional SPC configuration parameters to include in the SPC-Config. Accordingly, the MN 105A may combine or aggregate the different portions of the SPC configuration from the S-SN 105C and/or the T-SN 105D as well as any SPC configuration parameters determined by the MN 105A for the SPC-Config.

At step 525, the UE 115 determines that one or more trigger conditions have been met for the PScell change based on the SPC configuration transmitted at step 520. In some aspects, the conditions may be based on timer values or thresholds indicated in the SPC configuration. For example, the UE 115 may determine that the PScell change is successful based on one or more of a T304 threshold, a T310 threshold, and/or a T312 threshold.

At step 530, the UE 115 transmits, to the MN 105A based on the SPC configuration and the determination of step 525, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the MN 105A indicating that the successful PScell change information is available. In other aspects, the successful PScell change information may be carried and/or indicated in a RRC message and/or a media access control-control element (MAC-CE).

At step 535, the MN transmits, to the S-SN 105C, a SN change confirmation. In some aspects, the SN change confirmation comprises an Xn message.

At step 540, the MN 105A transmits, to the T-SN 105D, a SN Reconfiguration complete message. In some aspects, the transmitting SN Reconfiguration complete message includes transmitting an Xn message including or indicating the SN Reconfiguration complete message.

At step 545, the MN 105A transmits, to the UE 115 based on the indication that PScell change information is available, an information request. In some aspects, the information request may include a UEInformationRequest message including or indicating a SPC report request. In some aspects, the UEInformationRequest message may comprise a RRC message or IE.

At step 550, the UE 115 transmits, to the MN 105A, a UE information response or report based on the information request transmitted at step 540. In some aspects, the UE information response includes a UEInformationResponse message including or indicating a SPC report. In some aspects, the SPC report may comprise information associated with the PScell change. In some aspects, the UEInformationResponse message may comprise a RRC message or IE.

At step 555, the MN 105A transmits or forwards the SPC report included in the UE Information Response to the S-SN 105C. In some aspects, step 555 may comprise transmitting a Xn message indicating one or more of the parameters of the SPC report included in the UE information response transmitted at step 550.

At step 560, based on the SPC report, the MN 105A performs one or more network optimizations. For example, in some aspects, the MN 105A may update one or more timer thresholds associated with radio link monitoring (RLM) and/or beam failure detection (BFD) of a MCG and/or SCG. In another aspect, the MN 105A may detect near failure scenarios during a successful PScell change and/or a successful handover (HO).

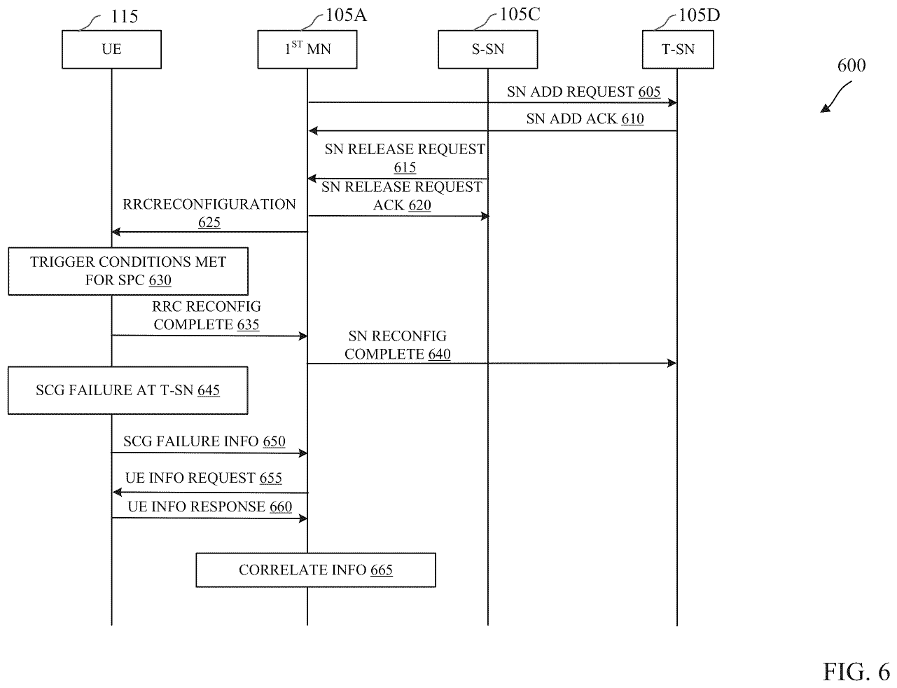

FIG. 6 is a signaling diagram illustrating a PScell change procedure 600 facilitated or otherwise controlled by a MN according to some aspects of the present disclosure. The PScell change procedure 600 may include a MN 105A, a S-SN 105C, a T-SN 105D, a UE 115, which may be examples of the corresponding devices described with reference to FIGS. 1A-2. In some examples, the PScell change procedure 600 may implement aspects of the wireless communications system 100 and 200. For example, the MN 105A, the S-SN 105C, the T-SN 105D, and the UE 115, may support a PScell change procedure in which the MN configures the UE 115 to determine a successful PScell change and/or for PScell change reporting. As illustrated, the PScell change procedure 600 includes a number of enumerated steps, but embodiments of the PScell change procedure 600 may include additional steps before, after, and in between the enumerated steps. In some embodiments, one or more of the enumerated steps may be omitted or performed in a different order. In the following description of the PScell change procedure 600, the operations between the MN 105A, S-SN 105C, the T-SN 105D, and/or the UE 115 may be transmitted in a different order or at different times than the exemplary order shown. Certain operations may also be left out of the PScell change procedure 600, or other operations may be added to the PScell change procedure 600.

At step 605, a MN 105A transmits a SN addition request to a T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the MN may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the MN 105A, S-SN 105C, and/or any other network node or device, a report indicating the channel measurements. For example, the UE 115 may transmit, to the MN 105A and/or to the S-SN 105C, a channel state information (CSI) report based on the channel measurements. A network node, such as the MN 105A, may determine to perform a PScell change based on the report.

At step 610, the T-SN 105D transmits, to the MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information.

At step 615, the MN 105A transmits, to the S-SN 105C, a SN release request requesting that the S-SN 105C release or discontinue communications with the UE 115. In some aspects, the SN release request may comprise an Xn message.

At step 620, the S-SN 105C transmits, to the MN 105A, a SN release request acknowledgement based on the SN release request. In some aspects, the SN release request acknowledgement may comprise an Xn message.

At step 625, the MN 105A transmits, to the UE 115, a RRCReconfiguration message. The RRCReconfiguration message may comprise or indicate a successful PScell change (SPC) configuration. In some aspects, the SPC configuration may comprise a SPC-Config. In some aspects, the SPC-Config may include or indicate information for the PScell change. For example, the SPC configuration may indicate one or more trigger events and/or conditions to determine whether the PScell change is successful. In some aspects, the SPC configuration may include or indicate one or more timer values or other thresholds that the UE 115 may use to determine whether the PScell change is successful. For example, the SPC configuration may include at least one of a T304 threshold, a T310 threshold, and/or a T312 threshold. In the illustrated example, the MN 105A may configure the SPC configuration autonomously. However, in other examples, (e.g., as illustrated in FIG. 5), the SPC configuration may be configured and/or determined by one or more other network nodes, such as the S-SN 105C and/or the T-SN 105D.

At step 630, the UE 115 determines that one or more trigger conditions have been met for the PScell change based on the SPC configuration transmitted at step 625. In some aspects, the conditions may be based on timer values or thresholds indicated in the SPC configuration. For example, the UE 115 may determine that the PScell change is successful based on one or more of a T304 threshold, a T310 threshold, and/or a T312 threshold.

At step 635, the UE 115 transmits, to the MN 105A based on the SPC configuration and the determination of step 630, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the MN 105A indicating that the successful PScell change information is available. In other aspects, the successful PScell change information may be carried and/or indicated in a RRC message and/or a media access control-control element (MAC-CE).

At step 640, the MN 105A transmits, to the T-SN 105D, a SN Reconfiguration complete message. In some aspects, the SN Reconfiguration complete message includes transmitting an Xn message including or indicating the SN Reconfiguration complete message.

At step 645, the UE 115 determines or detects a SCG failure at the T-SN. In some aspects, the SCG failure may occur before the PScell change has completed. In some aspects, detecting the SCG failure may comprise determining that one or more signals or messages were not successfully received. In another aspect, determining the SCG failure may comprise determining or detecting a radio link failure, a failure of SCG reconfiguration, a SCG integrity failure, exceeding a maximum uplink transmission timing difference, a random access failure, and/or any other suitable method of detecting a SCG failure.

At step 650, based on detecting the SCG failure, the UE 115 transmits, to the MN 105A, SCG failure information. In some aspects, the SCG failure information includes or indicates information associated with the SCG failure, such as the failure type or the condition that resulted in the SCG failure. In some aspects, the failure type may include an expiration of a T310 timer, a random access problem, a sync reconfiguration failure, a SRB3 integrity failure, and/or any other relevant failure type. In some aspects, the network may use the SCG failure information to modify or update subsequent SCG configurations.

At step 655, the MN 105A transmits, to the UE 115 based on the SCG failure information transmitted at step 650, an information request. In some aspects, the information request may include a UEInformationRequest message including or indicating a SPC report request. In some aspects, the UEInformationRequest message may comprise a RRC message or IE.

At step 650, the UE 115 transmits, to the MN 105A, a UE information response or report based on the information request transmitted at step 640. In some aspects, the UE information response includes a UEInformationResponse message including or indicating a SPC report. In some aspects, the SPC report may comprise information associated with the PScell change. In some aspects, the UEInformationResponse message may comprise a RRC message or IE.

At step 655, based on the SPC report, the MN 105A performs one or more network optimizations as explained above.

In some aspects, the MN may correlate information from the SPC report and the SCG failure information, and use the correlated information to perform the network optimizations. In some aspects, the MN 105A may correlate the SPC report and the SCG failure information based on UE context associated with the SPC report and the SCG failure information. In other instances, the UE context may not be available. For example, the MN 105A may periodically delete the UE context such that the SPC report and the SCG failure information may not be correlated by UE context. In some aspects, the MN 105A may be configured to correlate the SPC report and the SCG failure information based on one or more other identifiers or indicators in at least one of the SPC report and/or the SCG failure information.

For example, in some aspects, the SCG failure information may include a SPC report indicator indicating that the SPC report has been sent to the network for the handover and/or SN change. In another example, the SCG failure information may include a SPC Report indicator indicating that there is an SPC report associated with the handover. In another example, the SPC report and the SCG failure information may include or indicate a same C-RNTI. In another aspect, the MN 105A may correlate the SCG failure information and the SPC report based on their associated timestamps. For example, the MN 105A may determine that the SPC report is correlated with SCG failure information that is received within a time threshold of the SPC report. In another aspect, the MN 105A may merge the SPC report with the SCG failure information if the SPC report has not been sent by the time the SCG failure information is generated. In another aspect, the MN 105A may merge the SCG failure information with the SPC report if the SCG failure information has not been sent by the time the SPC report is generated. In another aspect, if the SCG failure occurs within a certain time window after the generation of the SPC report, the MN 105A may discard the SPC report. In another aspect, the UE 115 may add a tag or reference indicator to the

SPC report and to the SCG failure information. The reference indicator may be used to correlate the SPC report and the SCG failure information.

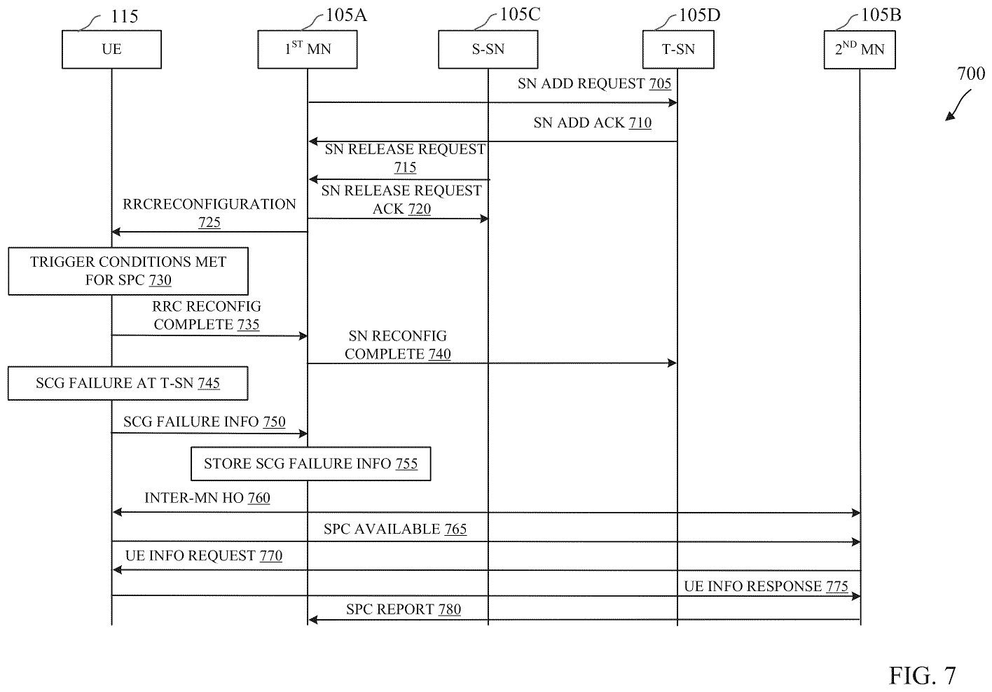

FIG. 7 is a signaling diagram illustrating a PScell change procedure 700 facilitated or otherwise controlled by a MN according to some aspects of the present disclosure. The PScell change procedure 700 may include a first MN 105A, a second MN 105B, a S-SN 105C, a T-SN 105D, a UE 115, which may be examples of the corresponding devices described with reference to FIGS. 1A-2. In some examples, the PScell change procedure 700 may implement aspects of the wireless communications system 100 and 200. For example, the first MN 105A, the S-SN 105C, the T-SN 105D, and the UE 115, may support a PScell change procedure in which the MN configures the UE 115 to determine a successful PScell change and/or for PScell change reporting. As illustrated, the PScell change procedure 700 includes a number of enumerated steps, but embodiments of the PScell change procedure 700 may include additional steps before, after, and in between the enumerated steps. In some embodiments, one or more of the enumerated steps may be omitted or performed in a different order. In the following description of the PScell change procedure 700, the operations between the first MN 105A, S-SN 105C, the T-SN 105D, and/or the UE 115 may be transmitted in a different order or at different times than the exemplary order shown. Certain operations may also be left out of the PScell change procedure 700, or other operations may be added to the PScell change procedure 700.

At step 705, a MN 105A transmits a SN addition request to a T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the MN may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the first MN 105A, S-SN 105C, and/or any other network node or device, a report indicating the channel measurements. For example, the UE 115 may transmit, to the first MN 105A and/or to the S-SN 105C, a channel state information (CSI) report based on the channel measurements. A network node, such as the first MN 105A, may determine to perform a PScell change based on the report.

At step 710, the T-SN 105D transmits, to the first MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information.

At step 715, the first MN 105A transmits, to the S-SN 105C, a SN release request requesting that the S-SN 105C release or discontinue communications with the UE 115. In some aspects, the SN release request may comprise an Xn message.

At step 720, the S-SN 105C transmits, to the first MN 105A, a SN release request acknowledgement based on the SN release request. In some aspects, the SN release request acknowledgement may comprise an Xn message.

At step 725, the first MN 105A transmits, to the UE 115, a RRCReconfiguration message. The RRCReconfiguration message may comprise or indicate a successful PScell change (SPC) configuration. In some aspects, the SPC configuration may comprise a SPC-Config. In some aspects, the SPC-Config may include or indicate information for the PScell change. For example, the SPC configuration may indicate one or more trigger events and/or conditions to determine whether the PScell change is successful. In some aspects, the SPC configuration may include or indicate one or more timer values or other thresholds that the UE 115 may use to determine whether the PScell change is successful. For example, the SPC configuration may include at least one of a T304 threshold, a T310 threshold, and/or a T312 threshold. In the illustrated example, the first MN 105A may configure the SPC configuration autonomously. However, in other examples, (e.g., as illustrated in FIG. 5), the SPC configuration may be configured and/or determined by one or more other network nodes, such as the S-SN 105C and/or the T-SN 105D.

At step 730, the UE 115 determines that one or more trigger conditions have been met for the PScell change based on the SPC configuration transmitted at step 725. In some aspects, the conditions may be based on timer values or thresholds indicated in the SPC configuration. For example, the UE 115 may determine that the PScell change is successful based on one or more of a T304 threshold, a T310 threshold, and/or a T312 threshold.

At step 735, the UE 115 transmits, to the first MN 105A based on the SPC configuration and the determination of step 730, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the first MN 105A indicating that the successful PScell change information is available. In other aspects, the successful PScell change information may be carried and/or indicated in a RRC message and/or a media access control-control element (MAC-CE).

At step 740, the first MN 105A transmits, to the T-SN 105D, a SN Reconfiguration complete message. In some aspects, the SN Reconfiguration complete message includes transmitting an Xn message including or indicating the SN Reconfiguration complete message.

At step 745, the UE 115 determines or detects a SCG failure at the T-SN. In some aspects, the SCG failure may occur before the PScell change has completed. In some aspects, detecting the SCG failure may comprise determining that one or more signals or messages were not successfully received. In another aspect, determining the SCG failure may comprise determining or detecting a radio link failure, a failure of SCG reconfiguration, a SCG integrity failure, exceeding a maximum uplink transmission timing difference, a random access failure, and/or any other suitable method of detecting a SCG failure.

At step 750, based on detecting the SCG failure, the UE 115 transmits, to the first MN 105A, SCG failure information. In some aspects, the SCG failure information includes or indicates information associated with the SCG failure, such as the failure type or the condition that resulted in the SCG failure. In some aspects, the failure type may include an expiration of a T310 timer, a random access problem, a sync reconfiguration failure, a SRB3 integrity failure, and/or any other relevant failure type. In some aspects, the network may use the SCG failure information to modify or update subsequent SCG configurations.

At step 755, the first MN 105A stores at least a portion of the SCG failure information. In some aspects, the at SCG failure information may be indicated in a SCG failure report. In some aspects, the SCG failure information may include one or more trigger events or conditions associated with a SCG failure.

At step 760, the UE 115 and the second MN 105B perform a handover (HO) procedure from the first MN 105A to the second MN 105B. In some aspects, performing the HO may include transmitting a RRC reconfiguration message including a handover command instructing the UE 115 to handover from the first MN 105A to the second MN 105B, in which a handover execution phase begins. The handover command may include information associated with the second MN 105B, for example, a random access channel (RACH) preamble assignment for accessing the second MN 105B. During the handover execution phase, the UE 115 may execute the handover by performing a random access procedure with the second MN 105B.

At step 765, the UE 115 transmits, to the second MN 105B, an indication that a SPC report or SPC information is available.

At step 770, the second MN 105B transmits, to the UE 115 and based on receiving the indication that the SPC report is available, a UE information request. In some aspects, the information request may include a UEInformationRequest message including or indicating a SPC report request. In some aspects, the UEInformationRequest message may comprise a RRC message or IE.

At step 775, the UE 115 transmits, to the second MN 105B, a UE information response or report based on the information request transmitted at step 770. In some aspects, the UE information response includes a UEInformationResponse message including or indicating a SPC report. In some aspects, the SPC report may comprise information associated with the PScell change. In some aspects, the UEInformationResponse message may comprise a RRC message or IE.

At step 780, the second MN 105B transmits, to the first MN 105A, the SPC report. In some aspects, the SPC report may include or indicate at least a portion of the SPC information included in the UE information response transmitted at step 775.

In some aspects, based on the SPC report, the first MN 105A performs one or more network optimizations as explained above with respect to the procedures 400 and/or 500, for example.

In some aspects, the first MN 105A may correlate information from the SPC report and the SCG failure information, and use the correlated information to perform the network optimizations. In some aspects, the first MN 105A may correlate the SPC report and the SCG failure information based on UE context associated with the SPC report and the SCG failure information. In other instances, the UE context may not be available. For example, the first MN 105A may periodically delete the UE context such that the SPC report and the SCG failure information may not be correlated by UE context. In some aspects, the first MN 105A may be configured to correlate the SPC report and the SCG failure information based on one or more other identifiers or indicators in at least one of the SPC report and/or the SCG failure information.

For example, in some aspects, the SCG failure information may include a SPC report indicator indicating that the SPC report has been sent to the network for the handover and/or SN change. In another example, the SCG failure information may include a SPC Report indicator indicating that there is an SPC report associated with the handover. In another example, the SPC report and the SCG failure information may include or indicate a same C-RNTI. In another aspect, the first MN 105A may correlate the SCG failure information and the SPC report based on their associated timestamps. For example, the first MN 105A may determine that the SPC report is correlated with SCG failure information that is received within a time threshold of the SPC report. In another aspect, the first MN 105A may merge the SPC report with the SCG failure information if the SPC report has not been sent by the time the SCG failure information is generated. In another aspect, the first MN 105A may merge the SCG failure information with the SPC report if the SCG failure information has not been sent by the time the SPC report is generated. In another aspect, if the SCG failure occurs within a certain time window after the generation of the SPC report, the first MN 105A may discard the SPC report. In another aspect, the UE 115 may add a tag or reference indicator to the SPC report and to the SCG failure information. The reference indicator may be used to correlate the SPC report and the SCG failure information.

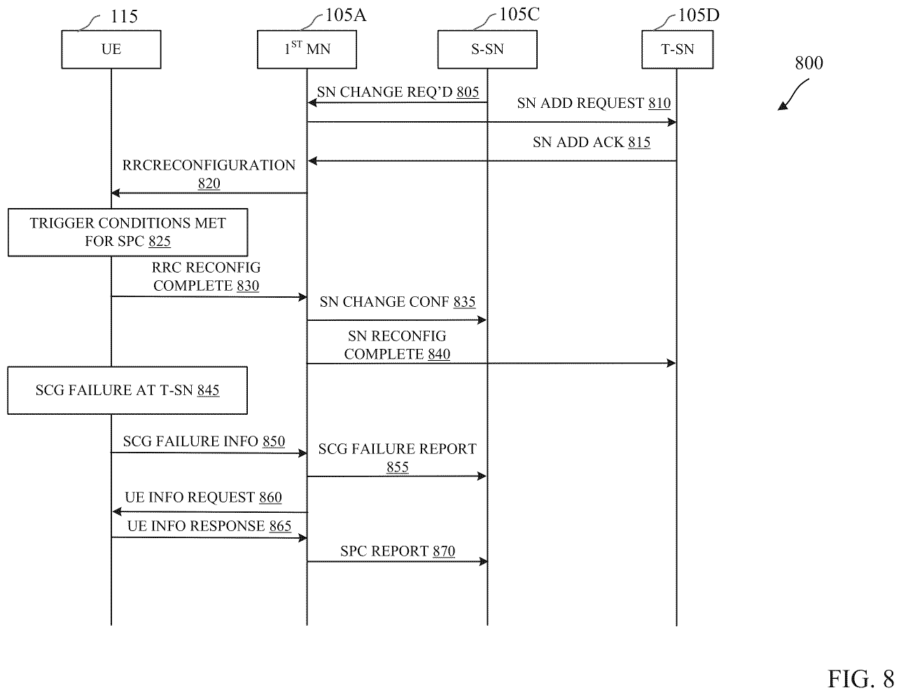

FIG. 8 is a signaling diagram illustrating a PScell change procedure 800 facilitated, initiated, and/or otherwise controlled by a SN according to some aspects of the present disclosure. The PScell change procedure 800 may include a MN 105A, a S-SN 105C, a T-SN 105D, a UE 115, which may be examples of the corresponding devices described with reference to FIGS. 1A-2. In some examples, the PScell change procedure 800 may implement aspects of the wireless communications system 100 and 200. For example, the MN 105A, the S-SN 105C, the T-SN 105D, and the UE 115, may support a PScell change procedure in which the SN initiates a PScell change and is at least partially involved in the configuration of the UE 115 to determine a successful PScell change and/or for PScell change reporting. The procedure 800 may further include mechanisms for reporting and correlating SCG failure information with SPC information. As illustrated, the PScell change procedure 800 includes a number of enumerated steps, but embodiments of the PScell change procedure 800 may include additional steps before, after, and in between the enumerated steps. In some embodiments, one or more of the enumerated steps may be omitted or performed in a different order. In the following description of the PScell change procedure 800, the operations between the MN 105A, S-SN 105C, the T-SN 105D, and/or the UE 115 may be transmitted in a different order or at different times than the exemplary order shown. Certain operations may also be left out of the PScell change procedure 800, or other operations may be added to the PScell change procedure 800.

At step 805, a S-SN 105C transmits, and the first MN 105A receives, a SN change required message causing the MN 105A to proceed with an SN addition, release, or other SN modification. In another aspect, the SN change required message may include or indicate one or more SPC configuration parameters. For example, the SN change required message may comprise a first portion of the SPC configuration. The S-SN 105C may determine and indicate in the SN change required message, at least one timer value or threshold. For example, the S-SN 105C may determine and indicate in the SN change required message at least one of a T310 timer value or threshold, and/or a T312 timer value or threshold.

At step 810, the first MN 105A transmits, based on the SN change required message received from the S-SN 105C, a SN addition request to a T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the first MN 105A may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the first MN 105A, S-SN 105C, and/or any other network node or device, a report indicating the channel measurements. For example, the UE 115 may transmit, to the first MN 105A and/or to the S-SN 105C, a channel state information (CSI) report based on the channel measurements. A network node, such as the first MN 105A, may determine to perform a PScell change based on the report.

At step 815, the T-SN 105D transmits, to the first MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information. In some aspects, the SN addition acknowledge message may include one or more SPC configuration parameters. In this regard, the PSC configuration may include a second portion of a SPC configuration. For example, in some aspects, the SN addition request acknowledgement message may include or indicate a T304 time value or threshold.

At step 820, the first MN 105A transmits, to the UE 115, a RRCReconfiguration message. The RRCReconfiguration message may comprise or indicate SPC configuration. In some aspects, the SPC configuration may comprise a SPC-Config. In some aspects, the SPC-Config may include or indicate information for the PScell change. For example, the SPC configuration may indicate a combination of SPC configuration parameters determined by the S-SN 105C and/or the T-SN 105D and indicated by the SN change required message transmitted at step 805 and/or the SN addition request acknowledgement message transmitted at step 815. In another aspect, the first MN 105A may determine one or more additional SPC configuration parameters to include in the SPC-Config. Accordingly, the first MN 105A may combine or aggregate the different portions of the SPC configuration from the S-SN 105C and/or the T-SN 105D as well as any SPC configuration parameters determined by the first MN 105A for the SPC-Config.

At step 825, the UE 115 determines that one or more trigger conditions have been met for the PScell change based on the SPC configuration transmitted at step 825. In some aspects, the conditions may be based on timer values or thresholds indicated in the SPC configuration. For example, the UE 115 may determine that the PScell change is successful based on one or more of a T304 threshold, a T310 threshold, and/or a T312 threshold.

At step 830, the UE 115 transmits, to the first MN 105A based on the SPC configuration and the determination of step 825, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the first MN 105A indicating that the successful PScell change information is available. In other aspects, the successful PScell change information may be carried and/or indicated in a RRC message and/or a media access control-control element (MAC-CE).

At step 835, the first MN 105A transmits, to the S-SN 105C, a SN change confirmation. In some aspects, the SN change confirmation comprises an Xn message.

At step 840, the first MN 105A transmits, to the T-SN 105D, a SN Reconfiguration complete message. In some aspects, the transmitting SN Reconfiguration complete message includes transmitting an Xn message including or indicating the SN Reconfiguration complete message.

At step 845, the UE 115 determines or detects a SCG failure at the T-SN. In some aspects, the SCG failure may occur before the PScell change has completed. In some aspects, detecting the SCG failure may comprise determining that one or more signals or messages were not successfully received. In another aspect, determining the SCG failure may comprise determining or detecting a radio link failure, a failure of SCG reconfiguration, a SCG integrity failure, exceeding a maximum uplink transmission timing difference, a random access failure, and/or any other suitable method of detecting a SCG failure.

At step 850, based on detecting the SCG failure, the UE 115 transmits, to the first MN 105A, SCG failure information. In some aspects, the SCG failure information includes or indicates information associated with the SCG failure, such as the failure type or the condition that resulted in the SCG failure. In some aspects, the failure type may include an expiration of a T310 timer, a random access problem, a sync reconfiguration failure, a SRB3 integrity failure, and/or any other relevant failure type. In some aspects, the network may use the SCG failure information to modify or update subsequent SCG configurations.

At step 855, the first MN 105A transmits a SCG failure report to the S-SN 105C. In some aspects, the SCG failure report transmitted at step 855 comprises an Xn message indicating the SCG failure information transmitted at step 850.

At step 860, the first MN 105A transmits, to the UE 115 based on the SCG failure information transmitted at step 850, an information request. In some aspects, the information request may include a UEInformationRequest message including or indicating a SPC report request. In some aspects, the UEInformationRequest message may comprise a RRC message or IE.

At step 865, the UE 115 transmits, to the first MN 105A, a UE information response or report based on the information request transmitted at step 860. In some aspects, the UE information response includes a UEInformationResponse message including or indicating a SPC report. In some aspects, the SPC report may comprise information associated with the PScell change. In some aspects, the UEInformationResponse message may comprise a RRC message or IE.

At step 870, the first MN 105A transmits, to the S-SN 105C, a SPC report. In some aspects, the SPC report may include a Xn message indicating the SPC information transmitted at step 865.

At step 875, based on the SPC report, the MN 105A performs one or more network optimizations.

In some aspects, the S-SN 105C may correlate information from the SPC report and the SCG failure information, and use the correlated information to perform the network optimizations. In some aspects, the S-SN 105C may correlate the SPC report and the SCG failure information based on UE context associated with the SPC report and the SCG failure information. In other instances, the UE context may not be available. For example, the S-SN 105C may periodically delete the UE context such that the SPC report and the SCG failure information may not be correlated by UE context. In some aspects, the S-SN 105C may be configured to correlate the SPC report and the SCG failure information based on one or more other identifiers or indicators in at least one of the SPC report and/or the SCG failure information.

For example, in some aspects, the SCG failure information may include a SPC report indicator indicating that the SPC report has been sent to the network for the handover and/or SN change. In another example, the SCG failure information may include a SPC Report indicator indicating that there is an SPC report associated with the handover. In another example, the SPC report and the SCG failure information may include or indicate a same C-RNTI. In another aspect, the S-SN 105C may correlate the SCG failure information and the SPC report based on their associated timestamps. For example, the S-SN 105C may determine that the SPC report is correlated with SCG failure information that is received within a time threshold of the SPC report. In another aspect, the S-SN 105C may merge the SPC report with the SCG failure information if the SPC report has not been sent by the time the SCG failure information is generated. In another aspect, the S-SN 105C may merge the SCG failure information with the SPC report if the SCG failure information has not been sent by the time the SPC report is generated. In another aspect, if the SCG failure occurs within a certain time window after the generation of the SPC report, the S-SN 105C may discard the SPC report. In another aspect, the UE 115 may add a tag or reference indicator to the SPC report and to the SCG failure information. The reference indicator may be used to correlate the SPC report and the SCG failure information.

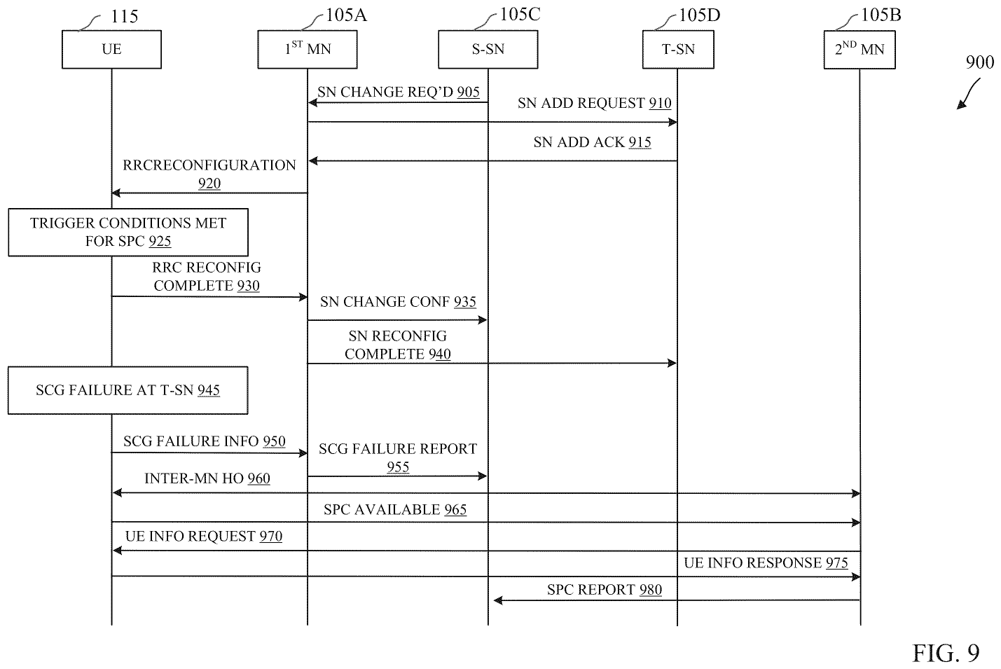

FIG. 9 is a signaling diagram illustrating a PScell change procedure 900 facilitated, initiated, and/or otherwise controlled by a SN according to some aspects of the present disclosure. The PScell change procedure 900 may include a MN 105A, a S-SN 105C, a T-SN 105D, a UE 115, which may be examples of the corresponding devices described with reference to FIGS. 1A-2. In some examples, the PScell change procedure 900 may implement aspects of the wireless communications system 100 and 200. For example, the MN 105A, the S-SN 105C, the T-SN 105D, and the UE 115, may support a PScell change procedure in which the SN initiates a PScell change and is at least partially involved in the configuration of the UE 115 to determine a successful PScell change and/or for PScell change reporting. The procedure 900 may further include mechanisms for reporting and correlating SCG failure information with SPC information. Further, the procedure 900 may involve initiating, resuming, or otherwise performing a handover (HO) procedure. As illustrated, the PScell change procedure 900 includes a number of enumerated steps, but embodiments of the PScell change procedure 900 may include additional steps before, after, and in between the enumerated steps. In some embodiments, one or more of the enumerated steps may be omitted or performed in a different order. In the following description of the PScell change procedure 900, the operations between the MN 105A, S-SN 105C, the T-SN 105D, and/or the UE 115 may be transmitted in a different order or at different times than the exemplary order shown. Certain operations may also be left out of the PScell change procedure 900, or other operations may be added to the PScell change procedure 900.

At step 905, a S-SN 105C transmits, and the first MN 105A receives, a SN change required message causing the MN 105A to proceed with an SN addition, release, or other SN modification. In another aspect, the SN change required message may include or indicate one or more SPC configuration parameters. For example, the SN change required message may comprise a first portion of the SPC configuration. The S-SN 105C may determine and indicate in the SN change required message, at least one timer value or threshold. For example, the S-SN 105C may determine and indicate in the SN change required message at least one of a T310 timer value or threshold, and/or a T312 timer value or threshold.

At step 910, the first MN 105A transmits, based on the SN change required message received from the S-SN 105C, a SN addition request to a T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the first MN 105A may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the first MN 105A, S-SN 105C, and/or any other network node or device, a report indicating the channel measurements. For example, the UE 115 may transmit, to the first MN 105A and/or to the S-SN 105C, a channel state information (CSI) report based on the channel measurements. A network node, such as the first MN 105A, may determine to perform a PScell change based on the report.

At step 915, the T-SN 105D transmits, to the first MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information. In some aspects, the SN addition acknowledge message may include one or more SPC configuration parameters. In this regard, the PSC configuration may include a second portion of a SPC configuration. For example, in some aspects, the SN addition request acknowledgement message may include or indicate a T304 time value or threshold.

At step 920, the first MN 105A transmits, to the UE 115, a RRCReconfiguration message. The RRCReconfiguration message may comprise or indicate SPC configuration. In some aspects, the SPC configuration may comprise a SPC-Config. In some aspects, the SPC-Config may include or indicate information for the PScell change. For example, the SPC configuration may indicate a combination of SPC configuration parameters determined by the S-SN 105C and/or the T-SN 105D and indicated by the SN change required message transmitted at step 905 and/or the SN addition request acknowledgement message transmitted at step 915. In another aspect, the first MN 105A may determine one or more additional SPC configuration parameters to include in the SPC-Config. Accordingly, the first MN 105A may combine or aggregate the different portions of the SPC configuration from the S-SN 105C and/or the T-SN 105D as well as any SPC configuration parameters determined by the first MN 105A for the SPC-Config.

At step 925, the UE 115 determines that one or more trigger conditions have been met for the PScell change based on the SPC configuration transmitted at step 925. In some aspects, the conditions may be based on timer values or thresholds indicated in the SPC configuration. For example, the UE 115 may determine that the PScell change is successful based on one or more of a T304 threshold, a T310 threshold, and/or a T312 threshold.

At step 930, the UE 115 transmits, to the first MN 105A based on the SPC configuration and the determination of step 925, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the first MN 105A indicating that the successful PScell change information is available. In other aspects, the successful PScell change information may be carried and/or indicated in a RRC message and/or a media access control-control element (MAC-CE).

At step 935, the first MN 105A transmits, to the S-SN 105C, a SN change confirmation. In some aspects, the SN change confirmation comprises an Xn message.

At step 940, the first MN 105A transmits, to the T-SN 105D, a SN Reconfiguration complete message. In some aspects, the transmitting SN Reconfiguration complete message includes transmitting an Xn message including or indicating the SN Reconfiguration complete message.

At step 945, the UE 115 determines or detects a SCG failure at the T-SN. In some aspects, the SCG failure may occur before the PScell change has completed. In some aspects, detecting the SCG failure may comprise determining that one or more signals or messages were not successfully received. In another aspect, determining the SCG failure may comprise determining or detecting a radio link failure, a failure of SCG reconfiguration, a SCG integrity failure, exceeding a maximum uplink transmission timing difference, a random access failure, and/or any other suitable method of detecting a SCG failure.

At step 950, based on detecting the SCG failure, the UE 115 transmits, to the first MN 105A, SCG failure information. In some aspects, the SCG failure information includes or indicates information associated with the SCG failure, such as the failure type or the condition that resulted in the SCG failure. In some aspects, the failure type may include an expiration of a T310 timer, a random access problem, a sync reconfiguration failure, a SRB3 integrity failure, and/or any other relevant failure type. In some aspects, the network may use the SCG failure information to modify or update subsequent SCG configurations.

At step 955, the first MN 105A transmits a SCG failure report to the S-SN 105C. In some aspects, the SCG failure report transmitted at step 955 comprises an Xn message indicating the SCG failure information transmitted at step 950.

At step 960, the UE 115 and the second MN 105B perform a handover (HO) procedure from the first MN 105A to the second MN 105B. In some aspects, performing the HO may include obtaining a measurement report from the UE 115, transmitting a HO request message to the second MN 105B, receiving a HO request acknowledge message from the second MN 105B, transmitting a RRC reconfiguration message to the UE 115, performing a random access procedure, and/or receiving a RRCReconfigurationComplete message from the UE 115.

At step 965, the UE 115 transmits, to the second MN 105B, an indication that a SPC report or SPC information is available.

At step 970, the second MN 105B transmits, to the UE 115 and based on receiving the indication that the SPC report is available, a UE information request. In some aspects, the information request may include a UEInformationRequest message including or indicating a SPC report request. In some aspects, the UEInformationRequest message may comprise a RRC message or IE.

At step 975, the UE 115 transmits, to the second MN 105B, a UE information response or report based on the information request transmitted at step 970. In some aspects, the UE information response includes a UEInformationResponse message including or indicating a SPC report. In some aspects, the SPC report may comprise information associated with the PScell change. In some aspects, the UEInformationResponse message may comprise a RRC message or IE.

At step 980, the second MN 105B transmits, to the S-SN 105C, the SPC report. In some aspects, the SPC report may include or indicate at least a portion of the SPC information included in the UE information response transmitted at step 975.

In some aspects, the S-SN 105C may correlate information from the SPC report and the SCG failure information, and use the correlated information to perform the network optimizations. In some aspects, the S-SN 105C may correlate the SPC report and the SCG failure information based on UE context associated with the SPC report and the SCG failure information. In other instances, the UE context may not be available. For example, the S-SN 105C may periodically delete the UE context such that the SPC report and the SCG failure information may not be correlated by UE context. In some aspects, the S-SN 105C may be configured to correlate the SPC report and the SCG failure information based on one or more other identifiers or indicators in at least one of the SPC report and/or the SCG failure information.

For example, in some aspects, the SCG failure information may include a SPC report indicator indicating that the SPC report has been sent to the network for the handover and/or SN change. In another example, the SCG failure information may include a SPC Report indicator indicating that there is an SPC report associated with the handover. In another example, the SPC report and the SCG failure information may include or indicate a same C-RNTI. In another aspect, the S-SN 105C may correlate the SCG failure information and the SPC report based on their associated timestamps. For example, the S-SN 105C may determine that the SPC report is correlated with SCG failure information that is received within a time threshold of the SPC report. In another aspect, the S-SN 105C may merge the SPC report with the SCG failure information if the SPC report has not been sent by the time the SCG failure information is generated. In another aspect, the S-SN 105C may merge the SCG failure information with the SPC report if the SCG failure information has not been sent by the time the SPC report is generated. In another aspect, if the SCG failure occurs within a certain time window after the generation of the SPC report, the S-SN 105C may discard the SPC report. In another aspect, the UE 115 may add a tag or reference indicator to the SPC report and to the SCG failure information. The reference indicator may be used to correlate the SPC report and the SCG failure information.

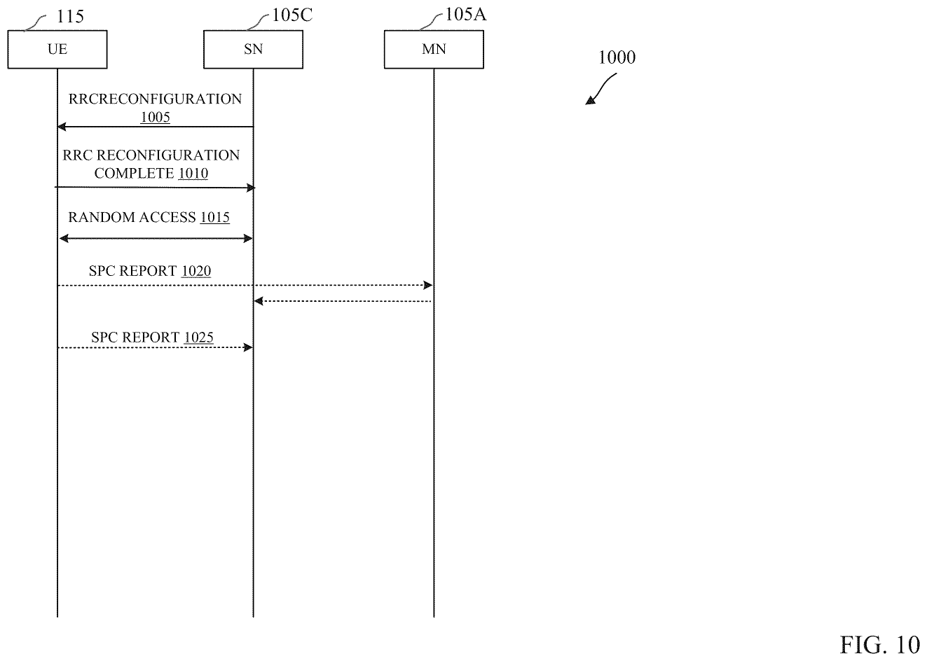

FIG. 10 is a signaling diagram illustrating a PScell change procedure 1000 facilitated or otherwise controlled by a SN with limited or no involvement by the MN, according to some aspects of the present disclosure. The PScell change procedure 1000 may include a MN 105A, a SN 105C, and a UE 115, which may be examples of the corresponding devices described with reference to FIGS. 1A-2. In some examples, the PScell change procedure 1000 may implement aspects of the wireless communications system 100 and 200. For example, the MN 105A, the SN 105C, and the UE 115 may support a PScell change procedure in which the SN 105C configures the UE 115 to determine a successful PScell change and/or for PScell change reporting. As illustrated, the PScell change procedure 1000 includes a number of enumerated steps, but embodiments of the PScell change procedure 1000 may include additional steps before, after, and in between the enumerated steps. In some embodiments, one or more of the enumerated steps may be omitted or performed in a different order. In the following description of the PScell change procedure 1000, the operations between the MN 105A, SN 105C, and/or the UE 115 may be transmitted in a different order or at different times than the exemplary order shown. Certain operations may also be left out of the PScell change procedure 1000, or other operations may be added to the PScell change procedure 1000.

At step 1005, the SN 105C transmits, to the UE 115, a RRCReconfiguration message. The RRCReconfiguration message may comprise or indicate a successful PScell change (SPC) configuration. In some aspects, the SPC configuration may comprise a SPC-Config. In some aspects, the SPC-Config may include or indicate information for the PScell change. For example, the SPC configuration may indicate one or more trigger events and/or conditions to determine whether the PScell change is successful. In some aspects, the SPC configuration may include or indicate one or more timer values or other thresholds that the UE 115 may use to determine whether the PScell change is successful. For example, the SPC configuration may include at least one of a T304 threshold, a T310 threshold, and/or a T312 threshold. In the illustrated example, the SN 105C may configure the SPC configuration autonomously.

At step 1010, the UE 115 transmits, to the SN 105C based on the SPC configuration, a RRC Reconfiguration Complete message. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the SN 105C indicating that the successful PScell change information is available. In other aspects, the successful PScell change information may be carried and/or indicated in a RRC message and/or a media access control-control element (MAC-CE).

At step 1015, the SN 105C and the UE 115 perform a random access procedure to change a PScell or configuration within the SN. In some aspects, the random access procedure comprises the addition, modification, or release of one SCG Scell and/or the release, modification, or addition of another SCG Scell.

In the procedure 1000, there may be at least two options for reporting SPC information to the SN 105C. A first option is shown as step 1020. The dashed lines indicate an optional or alternative step, with step 1025 also being optional or alternative to step 1020. In step 1020, the UE 115 transmits, to the MN 105A, an SPC report, and the MN 105A forwards the SPC report to the SN 105C. In some aspects, step 1020 comprises transmitting a UL signal from the UE 115 to the MN 105A, and the MN 105A transmitting a Xn message to the SN 105C indicating the SPC report. For example, step 1020 may comprise the MN 105A and/or the SN 105C transmitting a UE information request for an SPC report to the UE 115, and the UE 115 transmitting a UE information response based on the request to the MN 105A, where the UE information response includes the SPC report. The MN 105A may then transmit or forward the SPC information in the SPC report to the SN 105C in an Xn message. In some aspects, the UE 115 may transmit the SPC report to the MN 105A via SRB1.

In step 1025, which may be optional or alternative as described above, the UE 115 transmits the SPC report directly to the SN 105C. In some aspects, step 1025 may comprise the UE 115 transmitting the SPC report via a UL RRC message. In some aspects, the UE 115 may transmit the SPC report via SRB3 if SRB3 is available.

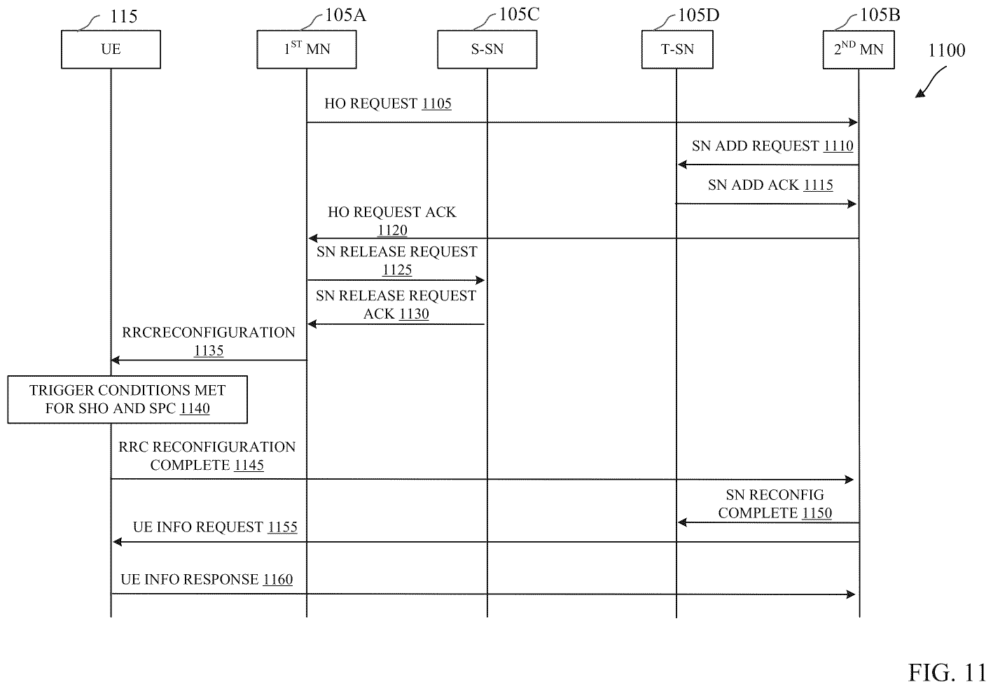

FIG. 11 is a signaling diagram illustrating a PScell change procedure 1100 facilitated or otherwise controlled by a MN according to some aspects of the present disclosure. The PScell change procedure 1100 may include a MN 105A, a S-SN 105C, a T-SN 105D, a UE 115, which may be examples of the corresponding devices described with reference to FIGS. 1A-2. In some examples, the PScell change procedure 1100 may implement aspects of the wireless communications system 100 and 200. For example, the MN 105A, the S-SN 105C, the T-SN 105D, and the UE 115, may support a PScell change procedure in which the MN configures the UE 115 to determine a successful PScell change and/or for PScell change reporting. As illustrated, the PScell change procedure 1100 includes a number of enumerated steps, but embodiments of the PScell change procedure 1100 may include additional steps before, after, and in between the enumerated steps. In some embodiments, one or more of the enumerated steps may be omitted or performed in a different order. In the following description of the PScell change procedure 1100, the operations between the MN 105A, S-SN 105C, the T-SN 105D, and/or the UE 115 may be transmitted in a different order or at different times than the exemplary order shown. Certain operations may also be left out of the PScell change procedure 1100, or other operations may be added to the PScell change procedure 1100.

At step 1105, the first MN 105A transmits, to the second MN 105B, a handover (HO) request. In some aspects, the HO request may include a Xn message.

At step 1110, the second MN 105B transmits a SN addition request to the T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the first MN 105A may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the first MN 105A, S-SN 105C, and/or any other network node or device, a report indicating the channel measurements. For example, the UE 115 may transmit, to the first MN 105A and/or to the S-SN 105C, a channel state information (CSI) report based on the channel measurements. A network node, such as the first MN 105A, may determine to perform a PScell change based on the report.

At step 1115, the T-SN 105D transmits, to the second MN 105B, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information.

At step 1120, the second MN 105B transmits, to the first MN 105A, a HO request acknowledgement. In some aspects, the HO request acknowledgement may include a Xn message.

At step 1125, the first MN 105A transmits, to the S-SN 105C, a SN release request requesting that the S-SN 105C release or discontinue communications with the UE 115. In some aspects, the SN release request may comprise an Xn message.

At step 1130, the S-SN 105C transmits, to the first MN 105A, a SN release request acknowledgement based on the SN release request. In some aspects, the SN release request acknowledgement may comprise an Xn message.

At step 1135, the first MN 105A transmits, to the UE 115, a RRCReconfiguration message. The RRCReconfiguration message may comprise or indicate a successful PScell change (SPC) configuration. In some aspects, the SPC configuration may comprise a SPC-Config. In some aspects, the SPC-Config may include or indicate information for the PScell change. For example, the SPC configuration may indicate one or more trigger events and/or conditions to determine whether the PScell change is successful. In some aspects, the SPC configuration may include or indicate one or more timer values or other thresholds that the UE 115 may use to determine whether the PScell change is successful. For example, the SPC configuration may include at least one of a T304 threshold, a T310 threshold, and/or a T312 threshold. In the illustrated example, the MN 105A may configure the SPC configuration autonomously. However, in other examples, (e.g., as illustrated in FIG. 5), the SPC configuration may be configured and/or determined by one or more other network nodes, such as the S-SN 105C and/or the T-SN 105D.

At step 1140, the UE 115 determines that one or more trigger conditions have been met for the successful PScell change based on the SPC configuration transmitted at step 1135, and that one or more trigger conditions have been met for the HO procedure initiated with the HO request transmitted at step 1105. In some aspects, the conditions may be based on timer values or thresholds indicated in the SPC configuration and/or in the HO request. For example, the UE 115 may determine that the PScell change is successful based on one or more of a T304 threshold, a T310 threshold, and/or a T312 threshold.

At step 1145, the UE 115 transmits, to the second MN 105B based on the determination of step 1140, a RRC Reconfiguration Complete message. In this regard, the RRC Reconfiguration Complete message is transmitted to the second MN 105B and may not be transmitted to the first MN 105A which initiated the SN release of the S-SN 105C. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the MN 105A indicating that the successful PScell change information is available. In other aspects, the successful PScell change information may be carried and/or indicated in a RRC message and/or a media access control-control element (MAC-CE). Further, the RRC Reconfiguration Complete message may include or indicate that successful HO information is available. For example, the RRC Reconfiguration Complete message may include or indicate a successHO-InfoAvailable field or flag indicating to the network that the successful HO information is available.

At step 1150, the second MN 105B transmits, to the T-SN 105D based on the RRC Reconfiguration Complete message, a SN Reconfiguration complete message. In some aspects, the SN Reconfiguration complete message includes transmitting an Xn message including or indicating the SN Reconfiguration complete message.

At step 1155, the second MN 105B transmits, to the UE 115 based on the indication that PScell change information is available and the indication that the HO information is available, an information request. In some aspects, the information request may include a UEInformationRequest message including or indicating a SPC report request and a successful HO report request. In some aspects, the UEInformationRequest message may comprise a RRC message or IE.

At step 1160, the UE 115 transmits, to the second MN 105B, a UE information response or report based on the information request transmitted at step 1140. In some aspects, the UE information response includes a UEInformationResponse message including or indicating a SPC report and a successful HO report. In some aspects, the SPC report may comprise information associated with the PScell change. The successful HO report may comprise information associated with the HO. In some aspects, the UEInformationResponse message may comprise a RRC message or IE. In some aspects, based on the SPC report and/or the successful HO report, the second MN 105B performs one or more network optimizations.

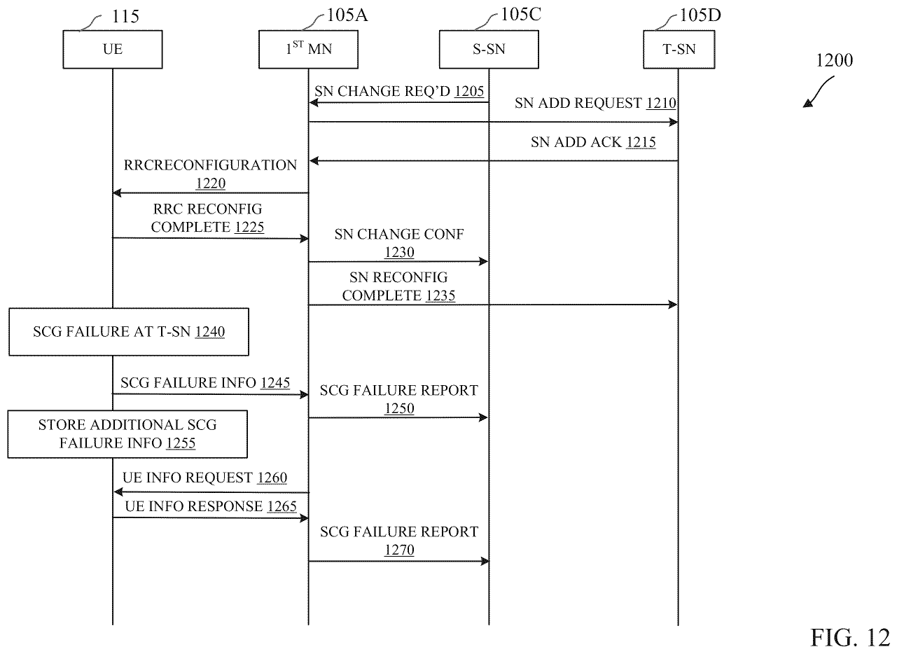

FIG. 12 is a signaling diagram illustrating a PScell change procedure 1200 facilitated, initiated, and/or otherwise controlled by a SN according to some aspects of the present disclosure. The PScell change procedure 1200 may include a MN 105A, a S-SN 105C, a T-SN 105D, a UE 115, which may be examples of the corresponding devices described with reference to FIGS. 1A-2. In some examples, the PScell change procedure 1200 may implement aspects of the wireless communications system 100 and 200. For example, the MN 105A, the S-SN 105C, the T-SN 105D, and the UE 115, may support a PScell change procedure in which the SN initiates a PScell change and is at least partially involved in the configuration of the UE 115 to determine a successful PScell change and/or for PScell change reporting. The procedure 1200 may further include mechanisms for reporting SCG failure information and additional SCG failure information. As illustrated, the PScell change procedure 1200 includes a number of enumerated steps, but embodiments of the PScell change procedure 1200 may include additional steps before, after, and in between the enumerated steps. In some embodiments, one or more of the enumerated steps may be omitted or performed in a different order. In the following description of the PScell change procedure 1200, the operations between the MN 105A, S-SN 105C, the T-SN 105D, and/or the UE 115 may be transmitted in a different order or at different times than the exemplary order shown. Certain operations may also be left out of the PScell change procedure 1200, or other operations may be added to the PScell change procedure 1200.

At step 1205, a S-SN 105C transmits, and the first MN 105A receives, a SN change required message causing the MN 105A to proceed with an SN addition, release, or other SN modification. In another aspect, the SN change required message may include or indicate one or more SPC configuration parameters. For example, the SN change required message may comprise a first portion of the SPC configuration. The S-SN 105C may determine and indicate in the SN change required message, at least one timer value or threshold. For example, the S-SN 105C may determine and indicate in the SN change required message at least one of a T310 timer value or threshold, and/or a T312 timer value or threshold.

At step 1210, the first MN 105A transmits, based on the SN change required message received from the S-SN 105C, a SN addition request to a T-SN 105D. In some aspects, transmitting the SN addition request may comprise transmitting an Xn message or signal indicating the SN addition request. In some aspects, the SN addition request message may provide or indicate RRC and/or data radio bearer (DRB) configuration information for changing the SN. In some aspects, the first MN 105A may transmit the SN addition request based on one or more reports and/or measurements obtained by the UE 115. In this regard, the UE 115 may obtain one or more channel measurements of a primary secondary cell group cell (PScell) facilitated by the S-SN 105C. The UE 115 may transmit, to the first MN 105A, S-SN 105C, and/or any other network node or device, a report indicating the channel measurements. For example, the UE 115 may transmit, to the first MN 105A and/or to the S-SN 105C, a channel state information (CSI) report based on the channel measurements. A network node, such as the first MN 105A, may determine to perform a PScell change based on the report.

At step 1215, the T-SN 105D transmits, to the first MN 105A, a SN addition acknowledgement. In some aspects, the SN addition acknowledgement may comprise an Xn message. In some aspects, the SN addition acknowledgement may include information for allocating resources, providing SCG resource configuration, and/or for providing any other suitable information. In some aspects, the SN addition acknowledge message may include one or more SPC configuration parameters. In this regard, the PSC configuration may include a second portion of a SPC configuration. For example, in some aspects, the SN addition request acknowledgement message may include or indicate a T304 time value or threshold.

At step 1220, the first MN 105A transmits, to the UE 115, a RRC Reconfiguration message. The RRC Reconfiguration message may comprise or indicate SPC configuration. In some aspects, the SPC configuration may comprise a SPC-Config. In some aspects, the SPC-Config may include or indicate information for the PScell change. For example, the SPC configuration may indicate a combination of SPC configuration parameters determined by the S-SN 105C and/or the T-SN 105D and indicated by the SN change required message transmitted at step 1205 and/or the SN addition request acknowledgement message transmitted at step 1215. In another aspect, the first MN 105A may determine one or more additional SPC configuration parameters to include in the SPC-Config. Accordingly, the first MN 105A may combine or aggregate the different portions of the SPC configuration from the S-SN 105C and/or the T-SN 105D as well as any SPC configuration parameters determined by the first MN 105A for the SPC-Config.

At step 1225, the UE 115 transmits, to the first MN 105A, a RRC Reconfiguration Complete message. In some instances, the transmitting the RRC Reconfiguration Complete message may be based on a determination that one or more trigger conditions for a successful PScell change have been met. The RRC Reconfiguration Complete message may include or indicate that successful PScell change information is available. For example, the RRC Reconfiguration Complete message may include or indicate a successPSCellChange-InfoAvailable field or flag indicating to the network that that the successful PScell change information is available. In some aspects, the successful PScell change information may include transmitting a UCI to the first MN 105A indicating that the successful PScell change information is available. In other aspects, the successful PScell change information may be carried and/or indicated in a RRC message and/or a media access control-control element (MAC-CE).

At step 1230, the first MN 105A transmits, to the S-SN 105C, a SN change confirmation. In some aspects, the SN change confirmation comprises an Xn message.

At step 1235, the first MN 105A transmits, to the T-SN 105D, a SN Reconfiguration complete message. In some aspects, the transmitting SN Reconfiguration complete message includes transmitting an Xn message including or indicating the SN Reconfiguration complete message.

At step 1240, the UE 115 determines or detects a SCG failure at the T-SN 105D. In some aspects, the SCG failure may occur before the PScell change has completed. In some aspects, detecting the SCG failure may comprise determining that one or more signals or messages related to the PScell change were not successfully received. In another aspect, determining the SCG failure may comprise determining or detecting a radio link failure, a failure of SCG reconfiguration, a SCG integrity failure, exceeding a maximum uplink transmission timing difference, a random access failure, and/or any other suitable method of detecting a SCG failure.

At step 1245, based on detecting the SCG failure, the UE 115 transmits, to the first MN 105A, SCG failure information. In some aspects, the SCG failure information includes or indicates information associated with the SCG failure, such as the failure type or the condition that resulted in the SCG failure. In some aspects, the failure type may include an expiration of a T310 timer, a random access problem, a sync reconfiguration failure, a SRB3 integrity failure, and/or any other relevant failure type. In some aspects, the network may use the SCG failure information to modify or update subsequent SCG configurations. In some aspects, the SCG failure information may include an indicator that additional SCG failure information is available, as further discussed below.

At step 1250, the first MN 105A transmits a SCG failure report to the S-SN 105C. In some aspects, the SCG failure report transmitted at step 1255 comprises an Xn message indicating the SCG failure information transmitted at step 1250.

At step 1255, the UE 115 stores additional SCG failure information. In some aspects, the UE 115 may store the additional SCG failure information in a VarSCGFailure-Report variable. In some aspects, as further explained below, the additional SCG failure information may be used to generate an additional SCG failure report. The additional SCG failure report may be similar to the SCG failure report transmitted at step 1250, in some aspects. The additional SCG failure information may include, for example, a first satisfied event of CPAC execution. In this regard, there may be multiple event triggers for conditional reconfiguration. In some aspects, a first conditional event may include a conditional reconfiguration candidate (e.g., target cell of a SCG) having better channel conditions (e.g., RSRP, RSRQ, SNR, etc.) than the serving Pcell and/or PScell by a configured offset. In this regard, the trigger event or condition may be met if the candidate RSRP, RSRQ, and/or SNR exceeds the current serving Pcell or PScell by the configured offset. In another aspect, a second conditional event may include the conditional reconfiguration candidate cell having better channel conditions (e.g., RSRP, RSRQ, SNR, etc.) than an absolute threshold. In another aspect, a third conditional event for conditional reconfiguration may include the current serving Pcell and/or PScell having channel conditions that fall below a first absolute threshold and the candidate cell having channel conditions that exceed a second absolute threshold. In some instances, multiple conditional events may occur to trigger the conditional reconfiguration. It may be beneficial for the network to receive information indicating which of the conditional events occurred first to cause or trigger the conditional reconfiguration. In another aspect, the additional SCG failure information may include a time or duration between the fulfillment of different conditional events or triggering conditions. For example, the additional SCG failure information may include or indicate the time between the first conditional event occurring and the last conditional event occurring. In another aspect, the additional SCG failure information may include the time between the first conditional event and the second conditional event, and the time between the second conditional event and the last conditional event to occur.

At step 1260, the first MN 105A transmits, to the UE 115 based on the SCG failure information transmitted at step 1245 indicating additional SCG failure information is available, an information request. In some aspects, the information request may include a UEInformationRequest message including or indicating an additional SCG failure information request. In some aspects, the UEInformationRequest message may comprise a RRC message or IE.

At step 1265, the UE 115 transmits, to the first MN 105A, a UE information response or report based on the information request transmitted at step 1260. In some aspects, the UE information response includes a UEInformationResponse message including or indicating an additional SCG failure report. In some aspects, the UEInformationResponse message may comprise a RRC message or IE.

At step 1270, the first MN 105A transmits, to the S-SN 105C, an SCG failure report including the additional SCG failure information. In some aspects, the SCG failure may include a Xn message indicating the SPC information transmitted at step 1265. In some aspects, the SCG failure report transmitted at step 1270 may have a similar or identical format as the SCG failure report transmitted at step 1250. In other aspects, a new report or report format may be configured for reporting the additional SCG failure information.

In the illustrated example, the UE 115 stores the additional SCG failure information and reports the additional SCG failure information based on a request from the network. In another example, the UE 115 may report the additional SCG failure information automatically, and not in response to a request for the additional information. In another aspect, upon detecting a different SCG failure, the previous stored additional SCG failure information may be overwritten with new additional SCG failure information. In some aspects, the UE 115 may store the additional SCG failure information in a configured variable. In some aspects, the UE 115 may store the additional SCG failure information for 24 hours, 48 hours, 72 hours, or any other suitable amount of time, greater or smaller. In another aspect, the UE 115 may store the additional SCG failure information until it is retrieved.

The UE 115 may indicate that the additional SCG failure information is available via a RRC message, in some aspects. For example, the UE 115 may indicate that the SCG failure information is available using one or more of a RRCSetupComplete message, a RRCResumeComplete message, a RRCReestablishmentComplete message, and/or a RRCReconfigurationComplete message.

At step 1275, based on the SPC report, the MN 105A performs one or more network optimizations.

In some aspects, the S-SN 105C may correlate information from the SPC report and the SCG failure information, and use the correlated information to perform the network optimizations. In some aspects, the S-SN 105C may correlate the SPC report and the SCG failure information based on UE context associated with the SPC report and the SCG failure information. In other instances, the UE context may not be available. For example, the S-SN 105C may periodically delete the UE context such that the SPC report and the SCG failure information may not be correlated by UE context. In some aspects, the S-SN 105C may be configured to correlate the SPC report and the SCG failure information based on one or more other identifiers or indicators in at least one of the SPC report and/or the SCG failure information.

For example, in some aspects, the SCG failure information may include a SPC report indicator indicating that the SPC report has been sent to the network for the handover and/or SN change. In another example, the SCG failure information may include a SPC Report indicator indicating that there is an SPC report associated with the handover. In another example, the SPC report and the SCG failure information may include or indicate a same C-RNTI. In another aspect, the S-SN 105C may correlate the SCG failure information and the SPC report based on their associated timestamps. For example, the S-SN 105C may determine that the SPC report is correlated with SCG failure information that is received within a time threshold of the SPC report. In another aspect, the S-SN 105C may merge the SPC report with the SCG failure information if the SPC report has not been sent by the time the SCG failure information is generated. In another aspect, the S-SN 105C may merge the SCG failure information with the SPC report if the SCG failure information has not been sent by the time the SPC report is generated. In another aspect, if the SCG failure occurs within a certain time window after the generation of the SPC report, the S-SN 105C may discard the SPC report. In another aspect, the UE 115 may add a tag or reference indicator to the SPC report and to the SCG failure information. The reference indicator may be used to correlate the SPC report and the SCG failure information.

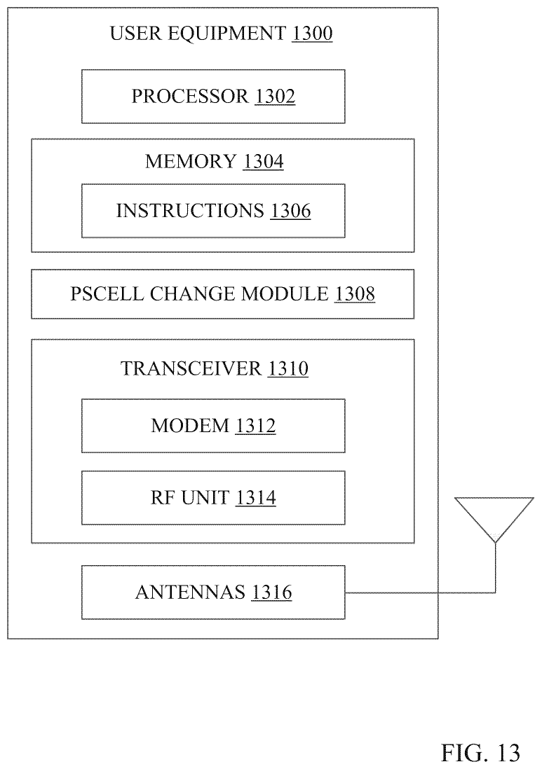

FIG. 13 is a block diagram of an exemplary UE 1300 according to some aspects of the present disclosure. The UE 1300 may be a UE 115 discussed in FIG. 1A or a UE 215 discussed in FIG. 2. As shown, the UE 1300 may include a processor 1302, a memory 1304, a PScell change module 1308, a transceiver 1310 including a modem subsystem 1312 and a radio frequency (RF) unit 1314, and one or more antennas 1316. These elements may be in direct or indirect communication with each other, for example via one or more buses.

The processor 1302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1302 may also be implemented as a combination of computing devices, e.g., a combination of a DSP and a microprocessor, a plurality of microprocessors, one or more microprocessors in conjunction with a DSP core, or any other such configuration.

The memory 1304 may include a cache memory (e.g., a cache memory of the processor 1302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1304 includes a non-transitory computer-readable medium. The memory 1304 may store, or have recorded thereon, instructions 1306. The instructions 1306 may include instructions that, when executed by the processor 1302, cause the processor 1302 to perform the operations described herein with reference to the UEs 115 in connection with aspects of the present disclosure, for example, aspects of FIGS. 1A-4 and 7-9. Instructions 1306 may also be referred to as program code. The program code may be for causing a wireless communication device to perform these operations, for example by causing one or more processors (such as processor 1302) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The PScell change module 1308 may be implemented via hardware, software, or combinations thereof. For example, the PScell change module 1308 may be implemented as a processor, circuit, and/or instructions 1306 stored in the memory 1304 and executed by the processor 1302. In some instances, the PScell change module 1308 can be integrated within the modem subsystem 1312. For example, the PScell change module 1308 can be implemented by a combination of software components (e.g., executed by a DSP or a general processor) and hardware components (e.g., logic gates and circuitry) within the modem subsystem 1312.

The PScell change module 1308 may be used for various aspects of the present disclosure, for example, aspects of FIGS. 4-12. The PScell change module 1308 may coordinate with the processor 1302 to obtain channel measurements of one or more cells in a master cell group (MCG) and/or in a secondary cell group (SCG). The PScell change module 1308 may be further configured to receive a successful PScell change (SPC) report configuration, and transmit a SPC report to the network based on the SPC report configuration. The PScell change module 1308 may be configured to detect a successful PScell change, and transmit the SPC report based on the SPC report configuration and the detecting the successful PScell change. In another aspect, the PScell change module 1308 may be configured to detect a SCG failure during and/or after the PScell change. The PScell change module 1308 may be configured to detect the SCG failure based on one or more SCG failure conditions or events, such as the expiration of a configured timer, a radio link failure, and/or any other suitable SCG failure condition. The PScell change module 1308 may be configured to transmit a SCG failure report to one or more network nodes. The PScell change module 1308 may be configured to store and report additional SCG failure information to the network. For example, the PScell change module 1308 may be configured to report a first-occurring triggering event or condition associated with the SCG failure and transmit an additional SCG failure report to the network indicating the additional SCG failure information.

As shown, the transceiver 1310 may include the modem subsystem 1312 and the RF unit 1314. The transceiver 1310 can be configured to communicate bi-directionally with other devices, such as the BS s 105. The modem subsystem 1312 may be configured to modulate and/or encode the data from the memory 1304 and/or the PScell change module 1308 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 1314 may be configured to process (e.g., perform analog to digital conversion or digital to analog conversion, etc.) modulated/encoded data (e.g., uplink data, synchronization signal, SSBs) from the modem subsystem 1312 (on outbound transmissions) or of transmissions originating from another source such as a UE 115 or a BS 105. The RF unit 1314 may be further configured to perform analog beamforming in conjunction with the digital beamforming. Although shown as integrated together in transceiver 1310, the modem subsystem 1312 and the RF unit 1314 may be separate devices that are coupled together at the UE 115 to enable the UE 115 to communicate with other devices.

The RF unit 1314 may provide the modulated and/or processed data, e.g. data packets (or, more generally, data messages that may contain one or more data packets and other information), to the antennas 1316 for transmission to one or more other devices. The antennas 1316 may further receive data messages transmitted from other devices. The antennas 1316 may provide the received data messages for processing and/or demodulation at the transceiver 1310. The transceiver 1310 may provide the demodulated and decoded data (e.g., reference signal, synchronization signal, SSBs) to the PScell change module 1308 for processing. The antennas 1316 may include multiple antennas of similar or different designs in order to sustain multiple transmission links. The RF unit 1314 may configure the antennas 1316. In some aspects, the RF unit 1314 may include various RF components, such as local oscillator (LO), analog filters, and/or mixers. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission and/or reception requirements at the UE 1300.

In some aspects, the transceiver 1310 is configured to receive a measurement configuration from the BS, the measurement configuration comprising the first signal measurement offset and a plurality of predetermined parameters. In some aspects, the UE receives the measurement configuration in a radio resource control (RRC) message. The transceiver 1310 is also configured to communicate, with the BS in a first subband of a plurality of subbands, a measurement report comprising indication of the occurrence of the specified measurement event for initiating a handover of the UE between the BS and the one or more neighbor cells.

In an aspect, the UE 1300 can include multiple transceivers 1310 implementing different RATs (e.g., NR and LTE). In an aspect, the UE 1300 can include a single transceiver 1310 implementing multiple RATs (e.g., NR and LTE). In an aspect, the transceiver 1310 can include various components, where different combinations of components can implement different RATs.

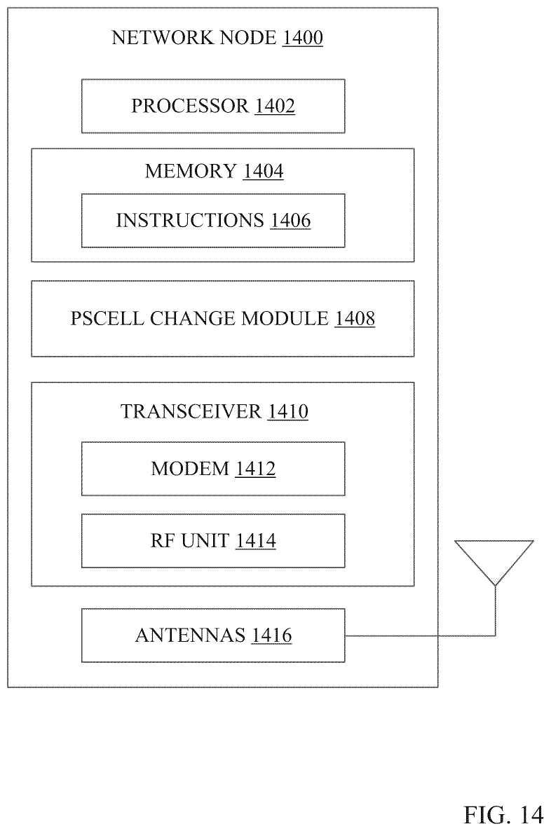

FIG. 14 is a block diagram of an exemplary network node 1400 according to some aspects of the present disclosure. The network node 1400 may be a BS 105 in the network 100 as discussed above in FIG. 1A or a BS 205 in the network 200 as discussed above in FIG. 2. As shown, the network node 1400 may include a processor 1402, a memory 1404, a PScell change module 1408, a transceiver 1410 including a modem subsystem 1412 and a RF unit 1414, and one or more antennas 1416. These elements may be in direct or indirect communication with each other, for example via one or more buses.

The processor 1402 may have various features as a specific-type processor. For example, these may include a CPU, a DSP, an ASIC, a controller, a FPGA device, another hardware device, a firmware device, or any combination thereof configured to perform the operations described herein. The processor 1402 may also be implemented as a combination of computing devices, e.g., a combination of a DSP and a microprocessor, a plurality of microprocessors, one or more microprocessors in conjunction with a DSP core, or any other such configuration.

The memory 1404 may include a cache memory (e.g., a cache memory of the processor 1402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1404 may include a non-transitory computer-readable medium. The memory 1404 may store instructions 1406. The instructions 1406 may include instructions that, when executed by the processor 1402, cause the processor 1402 to perform operations described herein, for example, aspects of FIGS. 1A-4 and 7-9. Instructions 1406 may also be referred to as code, which may be interpreted broadly to include any type of computer-readable statement(s) as discussed above with respect to FIG. 3.

The PScell change module 1408 may be implemented via hardware, software, or combinations thereof. For example, the PScell change module 1408 may be implemented as a processor, circuit, and/or instructions 1406 stored in the memory 1404 and executed by the processor 1402. In some instances, the PScell change module 1408 can be integrated within the modem subsystem 1412. For example, the PScell change module 1408 can be implemented by a combination of software components (e.g., executed by a DSP or a general processor) and hardware components (e.g., logic gates and circuitry) within the modem subsystem 1412.

The PScell change module 1408 may be implemented via hardware, software, or combinations thereof. For example, the PScell change module 1408 may be implemented as a processor, circuit, and/or instructions 1406 stored in the memory 1404 and executed by the processor 1402. In some examples, a BS may include the PScell change module 1408.

The PScell change module 1408 may be used for various aspects of the present disclosure, for example, aspects of FIGS. 4-12. The PScell change module 1408 may coordinate with the processor 1302 to receive channel measurements from the UE of one or more cells in a master cell group (MCG) and/or in a secondary cell group (SCG). The PScell change module 1408 may be further configured to transmit a successful PScell change (SPC) report configuration, and receive a SPC report from a UE based on the SPC report configuration. The PScell change module 1408 may be configured to receive the SPC report from the UE, where the report is based on the SPC report configuration. In another aspect, the PScell change module 1408 may be configured to receive a SCG failure report from the UE directly, or via one or more other network nodes. The PScell change module 1408 may be configured to store SCG failure information and/or SPC information. For example, the PScell change module 1408 may be configured to report a first-occurring triggering event or condition associated with the SCG failure and receive an additional SCG failure report indicating the additional SCG failure information.

In some aspects, the PScell change module 1408 may be configured to correlate a SPC report and a SCG failure report based on UE context associated with the SPC report and the SCG failure report. In another aspect, the PScell change module 1408 may be configured to correlate the SPC report and the SCG failure report based on one or more indicators in the SPC report and/or in the SCG report. In another aspect, the PScell change module 1408 may be configured to correlate the SPC report and the SCG failure report based on a timing of the SPC report and/or of the SCG report. In some aspects, the PScell change module 1408 may be configured to configure a UE for SPC reporting. In some aspects, the SPC reporting configuration may indicate one or more timer thresholds, such as a T304 timer threshold, a T310 timer threshold, and/or a T312 timer threshold for the UE to determine or detect a successful PScell change. In other aspects, the PScell change module 1408 may be configured to determine a portion of the SPC reporting configuration. In some aspects, the PScell change module 1408 may be configured to aggregate SPC reporting configuration parameters determined by the PScell change module 1408 and at least one other network node, and transmit a SPC reporting configuration including the aggregated SPC reporting parameters.

As shown, the transceiver 1410 may include the modem subsystem 1412 and the RF unit 1414. The transceiver 1410 can be configured to communicate bi-directionally with other devices, such as the UEs 115 and/or 500 and/or another core network element. The modem subsystem 1412 may be configured to modulate and/or encode data according to a MCS, e.g., a LDPC coding scheme, a turbo coding scheme, a convolutional coding scheme, a polar coding scheme, a digital beamforming scheme, etc. The RF unit 1414 may be configured to process (e.g., perform analog to digital conversion or digital to analog conversion, etc.) modulated/encoded data (e.g., PDCCH, PDSCH, SSBs, UE reporting configuration, machine learning-based network configuration) from the modem subsystem 1412 (on outbound transmissions) or of transmissions originating from another source such as a UE 115 and/or UE 500. The RF unit 1414 may be further configured to perform analog beamforming in conjunction with the digital beamforming. Although shown as integrated together in transceiver 1410, the modem subsystem 1412 and/or the RF unit 1414 may be separate devices that are coupled together at the BS 105 to enable the BS 105 to communicate with other devices.

The RF unit 1414 may provide the modulated and/or processed data, e.g. data packets (or, more generally, data messages that may contain one or more data packets and other information), to the antennas 1416 for transmission to one or more other devices. This may include, for example, transmission of information to complete attachment to a network and communication with a camped UE 115 or 500 according to some aspects of the present disclosure. The antennas 1416 may further receive data messages transmitted from other devices and provide the received data messages for processing and/or demodulation at the transceiver 1410. The transceiver 1410 may provide the demodulated and decoded data (e.g., CBR reports and/or CR reports) to the PScell change module 1408 for processing. The antennas 1416 may include multiple antennas of similar or different designs in order to sustain multiple transmission links.

In an aspect, the network node 1400 can include multiple transceivers 1410 implementing different RATs (e.g., NR and LTE). In an aspect, the network node 1400 can include a single transceiver 1410 implementing multiple RATs (e.g., NR and LTE). In an aspect, the transceiver 1410 can include various components, where different combinations of components can implement different RATs.

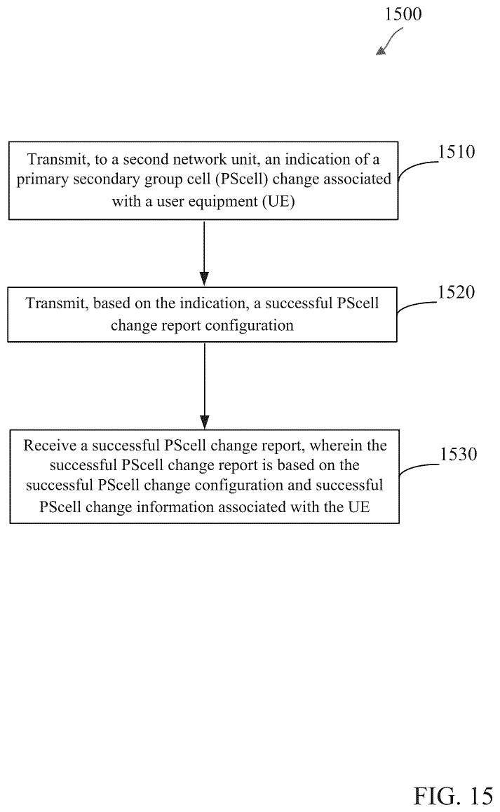

FIG. 15 is a flow diagram of a wireless communication method 1500 according to some aspects of the present disclosure. Aspects of the method 1500 can be executed by a computing device (e.g., a processor, processing circuit, and/or other suitable component) of a wireless communication device or other suitable means for performing the steps. For example, a wireless communication device may include a MN 105A, 105B, or a SN 105C, 105D. The wireless communication device may comprise the network node 1400 and may utilize one or more components, such as the processor 1402, the memory 1404, the PScell change module 1408, the transceiver 1410, the modem 1412, and the one or more antennas 1416, to execute the steps of method 1500. As illustrated, the method 1500 includes a number of enumerated steps, but aspects of the method 1500 may include additional steps before, after, and in between the enumerated steps. In some aspects, one or more of the enumerated steps may be omitted or performed in a different order.

At step 1510, a first network unit transmits, to a second network unit, an indication of a primary secondary group cell (PScell) change (SPC) associated with a user equipment (UE). In some aspects, the first network unit comprises a master node (MN). In another aspect, the first network unit comprises a secondary node (SN). In some aspects, the SN may be a source SN (S-SN) or a target SN (T-SN). The second network unit may comprise a SN, or a MN. In some aspects, if the first network unit is a MN, the second network unit may be a SN. In some aspects, transmitting the indication may comprise transmitting a Xn message including or carrying the indication. In some aspects, transmitting the indication of the SPC comprises transmitting at least one of a SN change required message, a SN addition request, a SN addition request acknowledgement, a SN release request, and/or a SN release request acknowledgement. The first network unit may utilize one or more components, such as the processor 1402, the memory 1404, the PScell change module 1408, the transceiver 1410, the modem 1412, and the one or more antennas 1416, to execute the actions of step 1510.

At step 1520, the first network unit transmits, based on the indication of the PScell change, a successful PScell change report (SPC) configuration. In some aspects, transmitting the SPC configuration may comprise transmitting a RRC message. For example, transmitting the SPC configuration may comprise transmitting a RRCReconfiguration message. In another aspect, transmitting the SPC configuration may comprise transmitting the configuration via a Xn message. In some aspects, the transmitting the SPC configuration comprises transmitting the SPC configuration from a MN directly to the UE. In another aspect, the transmitting the SPC configuration may comprise transmitting the SPC configuration, or at least a portion of a SPC configuration, from a SN to a MN via a Xn message. The first network unit may utilize one or more components, such as the processor 1402, the memory 1404, the PScell change module 1408, the transceiver 1410, the modem 1412, and the one or more antennas 1416, to execute the actions of step 1520.

At step 1530, the first network unit receives a SPC report. In some aspects, the SPC report is based on the SPC configuration and SPC information associated with the UE. For example, in some aspects, the UE may obtain SPC information based on the SPC configuration. The SPC information may include, for example, a trigger event or condition being met associated with the SPC procedure. In some aspects, receiving the SPC report comprises receiving the SPC report directly from the UE. In another aspect, receiving the SPC report comprises receiving the SPC report via a network unit, such as a MN or a SN. In some aspect, the receiving the SPC report may comprise receiving a UE information response including or indicating the SPC report. The UE information response may be transmitted by the UE in response to the UE receiving a UE information request. The UE information request may include or indicate a request for the SPC report. In another aspect, the first network unit may be a SN and may receive the SPC report via the MN. The first network unit may utilize one or more components, such as the processor 1402, the memory 1404, the PScell change module 1408, the transceiver 1410, the modem 1412, and the one or more antennas 1416, to execute the actions of step 1530.

In some aspects, the method 1500 further includes the first network unit or another network unit performing network optimizations based on the SPC report. For example, in some aspects, the first network unit or a different network unit may update one or more timer thresholds associated with radio link monitoring (RLM) and/or beam failure detection (BFD) of a MCG and/or SCG. In another aspect, the network unit may detect near failure scenarios during a successful PScell change and/or a successful handover (HO). In some aspects, the method 1500 further includes receiving a SCG failure report from the UE, wherein the SPC report is also received from the UE. The network unit may perform the network optimization based on a correlation of the SCG failure report with the SPC report.

In another aspect, the first network node receives the SPC report from a second MN different from the MN. In some aspects, the performing the network optimization is based on a correlation of the SCG failure report with the successful PScell change report. In some aspects, the first MN or the second MN may perform the network optimization.

In some aspects, the transmitting the indication of the SPC to the second network unit comprises transmitting a SN addition request message to a T-SN. In another aspect, transmitting the SPC report configuration comprises transmitting a SPC-Config, or a RRC message indicating the SPC-Config, to the UE. In some aspects, the SPC report configuration indicates one or more trigger thresholds for one or more timers associated with a MCG and/or a SCG.

In another aspect, the first network node comprises a SN, and the SN transmits the indication of the SPC by transmitting a SN change request to a MN. In some aspects, the transmitting the successful PScell change report configuration comprises transmitting a first SPC report configuration to the MN, and the receiving the SPC report comprises receiving the SPC report form the MN. In some aspects, the SN change request indicates a threshold for a first timer. For example, the SN change request may include or indicate at least one of a T310 timer threshold and/or a T312 timer threshold. In some aspects, the SN determines the threshold. In another aspect, the MN may determine a second timer threshold. For example, the MN may determine at least one of a T304 timer threshold, a T310 timer threshold, and/or a T312 timer threshold. In some aspects, the MN may receive the SN change request indicating the first timer threshold, and may transmit a SPC configuration indicating the first timer threshold and a second timer threshold, such that the SN and the MN contribute to the SPC configuration.

In some aspects, the method 1500 further comprises receiving a SCG failure report. For example, the MN may receive a SCG failure report from the UE. In another aspect, a SN may receive a SCG failure report from the MN. In SCG failure report may be based on a detection of a SCG failure. In some aspects, receiving the SCG failure report may comprise receiving a SCGFailureInformation information element from the UE. In another aspect, receiving the SCG failure report may include the SN receiving a Xn message indicating the SCG failure information from the MN. In some aspects, the first network node performs a network optimization based on the SCG failure information. In some aspects, the first network node performs a correlation of the SPC report and the SCG failure information, and performs the network optimization based on the correlation. In another aspect, the first network may correlate the SCG failure report and the SPC report based on one or more indicators included in the SCG failure report and/or the SPC report. For example, the SCG failure report may include a first indicator associated with the SPC report, the SPC report may include a second indicator associated with the SCG failure report, or a combination thereof.

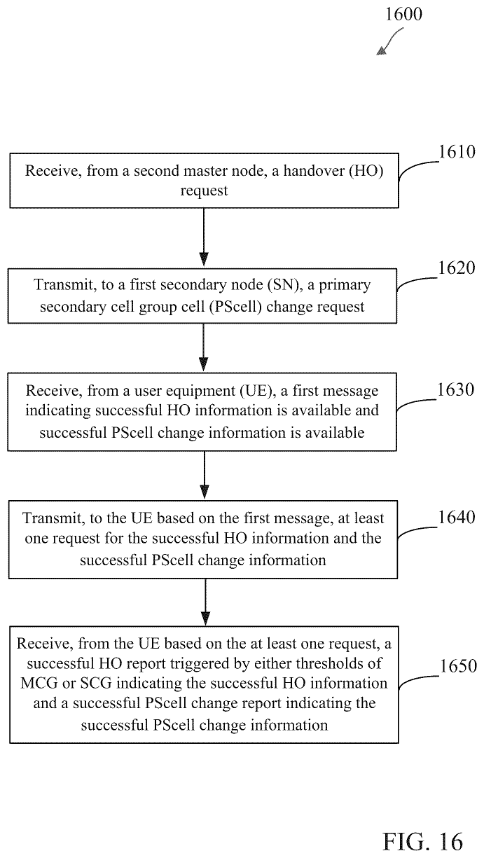

FIG. 16 is a flow diagram of a wireless communication method 1600 according to some aspects of the present disclosure. Aspects of the method 1600 can be executed by a computing device (e.g., a processor, processing circuit, and/or other suitable component) of a wireless communication device or other suitable means for performing the steps. For example, a wireless communication device may include a first MN 105A. The method 1600 may include one or more aspects of the procedure 1100 illustrated in FIG. 11. The first MN may comprise the network node 1400 and may utilize one or more components, such as the processor 1402, the memory 1404, the PScell change module 1408, the transceiver 1410, the modem 1412, and the one or more antennas 1416, to execute the steps of method 1600. As illustrated, the method 1600 includes a number of enumerated steps, but aspects of the method 1600 may include additional steps before, after, and in between the enumerated steps. In some aspects, one or more of the enumerated steps may be omitted or performed in a different order.

At step 1610, the first MN receives, from a second MN, a HO request. In some aspects, the HO request may comprise a Xn message. In some aspects, the second MN may trigger the HO based on a measurement report from a UE. In some aspects, the HO request may comprise an indication to an AMF that a HO is required or triggered. The first MN unit may utilize one or more components, such as the processor 1402, the memory 1404, the PScell change module 1408, the transceiver 1410, the modem 1412, and the one or more antennas 1416, to execute the actions of step 1610.

At step 1620, the first MN transmits, to a first SN, a PScell change request. In some aspects, transmitting the PScell change request comprises transmitting a SN addition request message. In some aspects, the PScell change request may comprise a Xn message. The first MN unit may utilize one or more components, such as the processor 1402, the memory 1404, the PScell change module 1408, the transceiver 1410, the modem 1412, and the one or more antennas 1416, to execute the actions of step 1620.

At step 1630, the first MN receives, from a UE, a first message indicating HO information is available and SPC information is available. In some aspects, the first message may comprise a RRCReconfigurationComplete message. The first MN unit may utilize one or more components, such as the processor 1402, the memory 1404, the PScell change module 1408, the transceiver 1410, the modem 1412, and the one or more antennas 1416, to execute the actions of step 1630.

At step 1640, the first MN transmits, to the UE based on the first message, at least one request for the HO information and the SPC information. In some aspects, the at least one request may comprise a UEInformationRequest indicating requests for both a successful HO (SHO) report and a SPC report. In another aspect, the at least one request may comprise separate UEInformationRequest messages, each indicating one of a SHO report request or a SPC report request.

At step 1650, the first MN receives, from the UE based on the at least one request, a SHO report and a SPC report. In some aspects, the SHO report is triggered by at least one of a threshold of a MCG or SCG. In some aspects, the SHO report indicates the SHO information the SPC report indicates the SPC information. In some aspects, the receiving the SHO report and the receiving the SPC report comprises receiving a single UEInformationResponse. In another aspect, the receiving the SHO report comprises receiving a first UEInformationResponse and the receiving the SPC report comprises receiving a second UEInformationResponse different from the first UEInformationResponse.

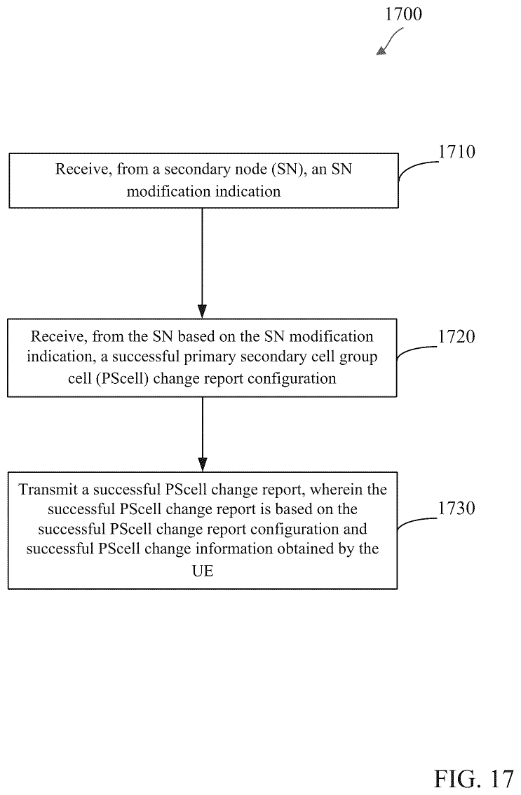

FIG. 17 is a flow diagram of a wireless communication method 1700 according to some aspects of the present disclosure. Aspects of the method 1700 can be executed by a computing device (e.g., a processor, processing circuit, and/or other suitable component) of a wireless communication device or other suitable means for performing the steps. For example, a wireless communication device may include a UE, such as one of the UEs 115. The method 1700 may include one or more aspects of the procedure 1000 illustrated in FIG. 10. In this regard, the method 1700 may include a SN initiating and/or otherwise controlling a PScell change with little or no involvement by the MN. The UE may utilize one or more components, such as the processor 1302, the memory 1304, the PScell change module 1308, the transceiver 1310, the modem 1312, and the one or more antennas 1316, to execute the steps of method 1700. As illustrated, the method 1700 includes a number of enumerated steps, but aspects of the method 1700 may include additional steps before, after, and in between the enumerated steps. In some aspects, one or more of the enumerated steps may be omitted or performed in a different order.

At step 1710, the UE receives, from a SN, a SN modification indication. In some aspects, receiving the SN modification indication comprises receiving a RRCReconfiguration message indicating a cell reconfiguration for the PScell. However, any suitable type of messaging may be received by the UE, including RRC IEs, MAC-CEs, DCI, and/or any other suitable messaging.

At step 1720, the UE receives, from the SN based on the SN modification indication, a SPC report configuration. In some aspects, the receiving the SPC report configuration comprises receiving a RRCReconfiguration message indicating the SPC report configuration. In some aspects, steps 1720 and 1710 may comprise receiving the same RRCReconfiguration message indicating both the SN modification and the SPC report configuration. In other aspects, separate messages may be received in steps 1710 and 1720, respectively, indicating the SN modification and the SPC report configuration.

At step 1730, the UE transmits a SPC report based on the SPC report configuration and SPC information obtained by the UE. In some aspects, the UE transmits the SPC report to the SN via SRB3. In another aspect, the UE transmits the SPC report to the MN via SRB1, and the MN transmits the SPC report to the SN. In some aspects, the UE may transmit a UEInformationResponse to the MN based on a UEInformationRequest from the MN. In other aspects, the UE may transmit the SPC report directly to the SN in a UL RRC message via SRB3 if SRB 3 is available.

In some aspects, the method 1700 includes the UE and a network node performing a random access procedure, as described above. In another aspect, the method 1700 includes the UE transmitting, based on the SN modification indication, a SN reconfiguration indication. For example, the UE may transmit a RRCReconfigurationComplete message to the SN.

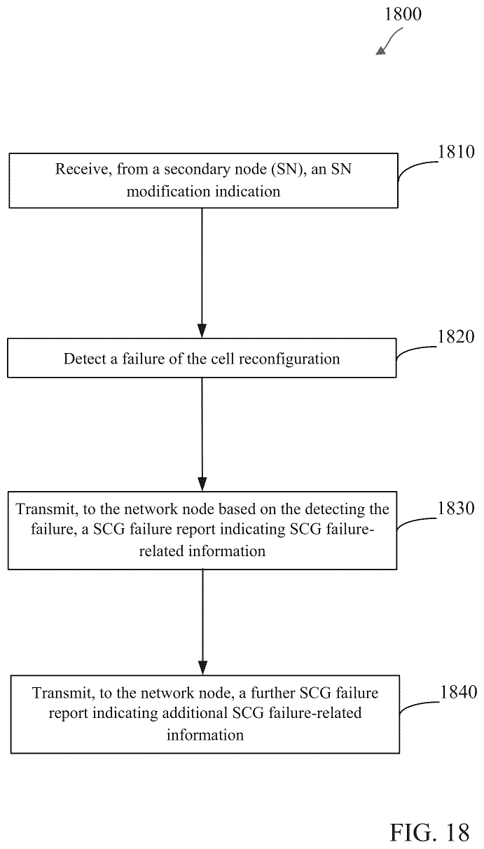

FIG. 18 is a flow diagram of a wireless communication method 1800 according to some aspects of the present disclosure. Aspects of the method 1800 can be executed by a computing device (e.g., a processor, processing circuit, and/or other suitable component) of a wireless communication device or other suitable means for performing the steps. For example, a wireless communication device may include a UE, such as one of the UEs 115. The method 1800 may include one or more aspects of the procedure 1200 shown in FIG. 12. The UE may utilize one or more components, such as the processor 1302, the memory 1304, the PScell change module 1308, the transceiver 1310, the modem 1312, and the one or more antennas 1316, to execute the steps of method 1800. As illustrated, the method 1800 includes a number of enumerated steps, but aspects of the method 1800 may include additional steps before, after, and in between the enumerated steps. In some aspects, one or more of the enumerated steps may be omitted or performed in a different order.

At step 1810, the UE receives, from a network node, an indication for a cell reconfiguration. In some aspects, the indication may include a RRCReconfiguration message indicating a reconfiguration of a PScell or Scell. In some aspects, the UE may receive the indication from a MN. The MN may transmit the indication based on channel measurements obtained and/or reported by the UE. For example, the channel measurements may be reported in a CSI report. The network node may determine that one or more conditions for the cell reconfiguration are met, and may transmit the indication based on the determination. In another aspect, the network node may receive a signal from a different network node, such as a SN, indicating that a SN change is required.

At step 1820, the UE detects a failure of the cell reconfiguration. In some aspects, detecting the failure may comprise detecting a SCG failure associated with the cell reconfiguration. In this regard, the SCG failure detection may be associated with or based on a SCG radio link failure, a failure of the SCG reconfiguration with sync, a control plane (e.g., SRB3) failure of the SCG configuration, a SCG integrity check failure, and/or exceeding a maximum UL transmission timing difference.

At step 1830, the UE transmits, to the network node based on the detecting the failure, a SCG failure report indicating SCG failure-related information. In some aspects, the UE may transmit a UCI indicating the SCG failure information. In another example, the UE may transmit a MAC-CE indicating the SCG failure information. In some aspects, the SCG failure information includes or indicates which of a plurality of failure conditions occurred. In some aspects, the SCG failure information may indicate a timer expiration, a random access problem, a max RLC re-transmission occurrence, and/or any other suitable information associated with the cell reconfiguration failure.

At step 1840, the UE transmits, to the network node, a further SCG failure report indicating additional SCG failure-related information different from the first SCG failure information. In some aspects, the UE may receive a request from the network node to transmit the further SCG failure report, and may transmit the further SCG failure report based on the request. In some aspects, the transmitting the further SCG failure information may comprise transmitting a UE information request indicating the second SCG failure information.

In another aspect, the second SCG failure information comprises at least one of an indication of a first satisfied conditional event for the cell reconfiguration, or a time duration between a first satisfied condition for the cell reconfiguration and a second satisfied condition for the cell reconfiguration. Ain another aspect, the SCG failure report may indicate that the second SCG failure information is available for transmission. The method 1800 may further include receiving a SCG failure information request from the network node, and the transmitting the further SCG failure report may be based on the SCG failure information request.

### EXEMPLARY ASPECTS OF THE DISCLOSURE

The present disclosure also includes and provides the following exemplary aspects:

Aspect 1. A method of wireless communication performed by a first network unit, wherein the method comprises: transmitting, to a second network unit, an indication of a primary secondary cell group cell (PScell) change associated with a user equipment (UE); transmitting, based on the indication, a successful PScell change (SPC) report configuration; and receiving a SPC report, wherein the SPC report is based on the SPC report configuration and SPC information associated with the UE.

Aspect 2. The method of aspect 1, wherein: the first network unit comprises a master node; the second network unit comprises a target secondary node (SN); the transmitting the indication of the SPC to the second network unit comprises transmitting a SN addition request to the target SN; and the transmitting the SPC report configuration comprises transmitting the SPC report configuration to the UE.

Aspect 3. The method of aspect 2, wherein: the SPC report configuration indicates one or more trigger thresholds for one or more timers associated with a Master Cell Group (MCG), a Secondary Cell Group (SCG), or both.

Aspect 4. The method of any of aspects 2-3, further comprising: performing a network optimization based on the SPC report, wherein the performing the network optimization comprises at least one of: updating a timer threshold associated with radio link monitoring (RLM) or Beam failure detection (BFD); or detecting near failure scenarios during a SPC or a successful handover.

Aspect 5. The method of aspect 4, further comprising: receiving, from the UE, a secondary cell group (SCG) failure report; wherein the receiving the SPC report comprises receiving the SPC report from the UE, and wherein the performing the network optimization is based on a correlation of the SCG failure report with the SPC report.

Aspect 6. The method of aspect 4, further comprising: receiving, from the UE, a secondary cell group (SCG) failure report; and wherein the receiving the SPC report comprises receiving the SPC report from a second master node different from the master node, and wherein the performing the network optimization is based on a correlation of the SCG failure report with the SPC report.

Aspect 7. The method of any of aspects 1-6, wherein: the first network unit comprises a secondary node (SN); the transmitting the indication of the PScell change to the second network unit comprises transmitting a SN change request to a master node; the transmitting the SPC report configuration comprises transmitting a first PScell change report configuration to the master node; and the receiving the SPC report comprises receiving the SPC report from the master node.

Aspect 8. The method of aspect 7, wherein: the SN change request indicates a threshold for a first timer, and wherein the SPC report is based on the first PScell change report configuration and a second PScell change report configuration, wherein the second PScell change report configuration indicates a threshold for a second timer associated with a target SN.

Aspect 9. The method of any of aspects 7-8, further comprising: performing a network optimization based on the SPC report.

Aspect 10. The method of aspect 9, further comprising: receiving, from the master node, a secondary cell group (SCG) failure report, wherein the receiving the SPC report comprises receiving the SPC report from the master node, and wherein the performing the network optimization is based on a correlation of the SCG failure report with the SPC report.

Aspect 11. The method of aspect 9, further comprising: receiving, from the master node, a secondary cell group (SCG) failure report, wherein the receiving the SPC report comprises receiving the SPC report from a second master node different from the master node, and wherein the performing the network optimization is based on a correlation of the SCG failure report with the SPC report.

Aspect 12. The method of any of aspects 1-11, further comprising: receiving a secondary cell group (SCG) failure report, wherein: the SCG failure report includes a first indicator associated with the SPC report, the SPC report includes a second indicator associated with the SCG failure report; or a combination thereof; and performing a network optimization based on a correlation of the SCG failure report with the SPC report, wherein the correlation is based on at least one of the first indicator or the second indicator.

Aspect 13. A method of wireless communication performed by a first master node, wherein the method comprises: receiving, from a second master node, a handover (HO) request; transmitting, to a first secondary node (SN), a primary secondary cell group cell (PScell) change request; receiving, from a user equipment (UE), a first message indicating successful HO information is available and SPC information is available; transmitting, to the UE based on the first message, at least one request for the successful HO information and the SPC information; and receiving, from the UE based on the at least one request, a successful HO report indicating the successful HO information and a SPC report indicating the SPC information.

Aspect 14. The method of aspect 13, further comprising: transmitting, to the UE, a successful HO report configuration indicating one or more trigger thresholds for one or more timers associated with at least one of a master cell group (MCG) or a secondary cell group (SCG), wherein the successful HO report is based on the successful HO report configuration.

Aspect 15. A method of wireless communication performed by a user equipment (UE), wherein the method comprises: receiving, from a secondary node (SN), an SN modification indication; receiving, from the SN based on the SN modification indication, a successful primary secondary cell group cell (PScell) change report configuration; and transmitting a SPC report, wherein the SPC report is based on the SPC report configuration and PScell change information associated with the UE.

Aspect 16. The method of aspect 15, wherein the transmitting the SPC report comprises transmitting the SPC report to a master node in communication with the SN.

Aspect 17. The method of aspect 15, wherein the transmitting the SPC report comprises transmitting the SPC report to the SN.

Aspect 18. A method of wireless communication performed by a user equipment (UE), wherein the method comprises: receiving, from a network node, a reconfiguration message for a PSCell change; detecting, based on the reconfiguration message, a PSCell change failure ; transmitting, to the network node based on the detecting the failure, a secondary cell group (SCG) failure report indicating SCG failure-related information; and transmitting, to the network node after the transmitting the SCG report, a further SCG failure report indicating additional SCG failure-related information.

Aspect 19. The method of aspect 18, wherein the further SCG failure report comprises at least one of: an indication of a first satisfied condition associated with the reconfiguration message for PSCell change; or a time duration between a first satisfied condition and a second satisfied condition associated with the reconfiguration message for PSCell change.

Aspect 20. The method of any of aspects 18-19, wherein: the UE indicates in at least one of the SCG failure report or the further SCG failure report that the additional SCG failure-related information is available for transmission; the method further comprises: receiving, from the network node, an additional SCG failure information request; and the transmitting the additional SCG failure report is based on the receiving the SCG failure information request.

Aspect 21. A first network unit comprises: a memory device; a transceiver; and a processor in communication with the processor and the transceiver, wherein the first network unit is configured to perform the actions of any of aspects 1-12.

Aspect 22. A first master node comprises: a memory device; a transceiver; and a processor in communication with the processor and the transceiver, wherein the first master node is configured to perform the actions of any of aspects 13-14.

Aspect 23. A UE comprises: a memory device; a transceiver; and a processor in communication with the processor and the transceiver, wherein the UE is configured to perform the actions of any of aspects 15-17.

Aspect 24. A UE comprises: a memory device; a transceiver; and a processor in communication with the processor and the transceiver, wherein the UE is configured to perform the actions of any of aspects 18-20.

Aspect 25. A non-transitory, computer-readable medium having program code recorded thereon, wherein the program code comprises instructions executable by a processor of a first network unit, wherein the instructions comprise code for causing the first network unit to perform the actions of any of aspects 1-12.

Aspect 26. A non-transitory, computer-readable medium having program code recorded thereon, wherein the program code comprises instructions executable by a processor of a first master node, wherein the instructions comprise code for causing the first master node to perform the actions of any of aspects 13-14.

Aspect 27. A non-transitory, computer-readable medium having program code recorded thereon, wherein the program code comprises instructions executable by a processor of a UE, wherein the instructions comprise code for causing the UE node to perform the actions of any of aspects 15-17.

Aspect 28. A non-transitory, computer-readable medium having program code recorded thereon, wherein the program code comprises instructions executable by a processor of a UE, wherein the instructions comprise code for causing the UE node to perform the actions of any of aspects 18-20.

Aspect 29. A first network unit comprising means for performing actions of any of aspects 1-12.

Aspect 30. A first master node comprising means for performing actions of any of aspects 13-14.

Aspect 31. A UE comprising means for performing actions of any of aspects 15-17.

Aspect 32. A UE comprising means for performing actions of any of aspects 18-20.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a first network unit, wherein the method comprises:
transmitting, to a second network unit, an indication of a primary secondary cell group cell (PScell) change associated with a user equipment (UE);
transmitting, based on the indication, a successful PScell change (SPC) configuration; and
receiving a SPC report, wherein the SPC report is based on the SPC configuration and SPC information associated with the UE.

2. The method of claim 1, wherein:
the first network unit comprises a master node;
the second network unit comprises a target secondary node (SN);
the transmitting the indication of the PScell change to the second network unit comprises transmitting a SN addition request to the target SN; and
the transmitting the SPC configuration comprises transmitting the SPC configuration to the UE.

3. The method of claim 2, wherein:
the SPC configuration indicates one or more trigger thresholds for one or more timers associated with a Master Cell Group (MCG), a Secondary Cell Group (SCG), or both.

4. The method of claim 2, further comprising:
performing a network optimization based on the SPC report.

5. The method of claim 4, wherein the performing the network optimization comprises updating a timer threshold associated with radio link monitoring (RLM) or Beam failure detection (BFD).

6. The method of claim 4, wherein the performing the network optimization comprises detecting near failure scenarios during a SPC or a successful handover.

7. The method of claim 4, further comprising:
receiving, from the UE, a secondary cell group (SCG) failure report,
wherein the receiving the SPC report comprises receiving the SPC report from the UE, and
wherein the performing the network optimization is based on a correlation of the SCG failure report with the SPC report.

8. The method of claim 4, further comprising:
receiving, from the UE, a secondary cell group (SCG) failure report,
wherein the receiving the SPC report comprises receiving the SPC report from a second master node different from the master node, and
wherein the performing the network optimization is based on a correlation of the SCG failure report with the SPC report.

9. The method of claim 1, wherein:
the first network unit comprises a secondary node (SN);
the transmitting the indication of the PScell change to the second network unit comprises transmitting a SN change request to a master node;
the transmitting the SPC configuration comprises transmitting a first PScell change report configuration to the master node; and
the receiving the SPC report comprises receiving the SPC report from the master node.

10. The method of claim 9, wherein:
the SN change request indicates a threshold for a first timer, and
wherein the SPC report is based on the first PScell change report configuration and a second PScell change report configuration, wherein the second PScell change report configuration indicates a threshold for a second timer associated with a target SN.

11. The method of claim 9, further comprising:
receiving, from the master node, a secondary cell group (SCG) failure report; and
performing a network optimization based on a correlation of the SCG failure report with the SPC report,
wherein the receiving the SPC report comprises receiving the SPC report from the master node.

12. The method of claim 9, further comprising:
receiving, from the master node, a secondary cell group (SCG) failure report; and
performing a network optimization based on a correlation of the SCG failure report with the SPC report,
wherein the receiving the SPC report comprises receiving the SPC report from a second master node different from the master node.

13. The method of claim 1, further comprising:
receiving a secondary cell group (SCG) failure report, wherein:
the SCG failure report includes a first indicator associated with the SPC report,
the SPC report includes a second indicator associated with the SCG failure report; or
a combination thereof; and
performing a network optimization based on a correlation of the SCG failure report with the SPC report, wherein the correlation is based on at least one of the first indicator or the second indicator.

14. A method of wireless communication performed by a user equipment (UE), wherein the method comprises:
receiving, from a network node, a reconfiguration message for a PSCell change;
detecting, based on the reconfiguration message, a PSCell change failure;
transmitting, to the network node based on the detecting the failure, a secondary cell group (SCG) failure report indicating SCG failure-related information; and
transmitting, to the network node after the transmitting the SCG report, a further SCG failure report indicating additional SCG failure-related information.

15. The method of claim 14, wherein the additional SCG failure-related information comprises at least one of:
an indication of a first satisfied condition associated with the reconfiguration message for PSCell change; or
a time duration between a first satisfied condition and a second satisfied condition associated with the reconfiguration message for the PSCell change.

16. A first network unit comprises:
a memory device;
a transceiver; and
a processor in communication with the processor and the transceiver, wherein the first network unit is configured to:
transmit, to a second network unit, an indication of a primary secondary cell group cell (PScell) change associated with a user equipment (UE);
transmit, based on the indication, a successful PScell change (SPC) configuration; and
receive a SPC report, wherein the SPC report is based on the SPC configuration and SPC information associated with the UE.

17. The first network unit of claim 16, wherein:
the first network unit comprises a master node;
the second network unit comprises a target secondary node (SN);
the first network unit configured to transmit the indication of the PScell change to the second network unit comprises the first network unit configured to transmit a SN addition request to the target SN; and
the first network unit is configured to transmit the SPC report to the UE.

18. The first network unit of claim 17, wherein:
the SPC configuration indicates one or more trigger thresholds for one or more timers associated with a Master Cell Group (MCG), a Secondary Cell Group (SCG), or both.

19. The first network unit of claim 17, wherein the first network unit is further configured to:
perform a network optimization based on the SPC report.

20. The first network unit of claim 19, wherein the network optimization comprises an update of a timer threshold associated with radio link monitoring (RLM) or Beam failure detection (BFD).

21. The first network unit of claim 19, wherein the network optimization comprises a detection of a near failure scenarios during a SPC or a successful handover.

22. The first network unit of claim 19, wherein the first network unit is further configured to:
receive, from the UE, a secondary cell group (SCG) failure report,
wherein the first network unit is configured to receive the SPC report from the UE, and
wherein the first network unit is configured to perform the network optimization based on a correlation of the SCG failure report with the SPC report.

23. The first network unit of claim 19, wherein the first network unit is further configured to:
receive, from the UE, a secondary cell group (SCG) failure report; and
wherein the first network unit is configured to receive the SPC report from the master node, and
wherein the first network unit is configured to perform the network optimization based on a correlation of the SCG failure report with the SPC report.

24. The first network unit of claim 16, wherein:
the first network unit comprises a secondary node (SN);
the first network unit configured to transmit the indication of the PScell change to the second network unit comprises the first network unit configured to transmit a SN change request to a master node;
the first network unit configured to transmit the SPC configuration comprises the first network unit configured to transmit a first PScell change report configuration to the master node; and
the first network unit is configured to receive the SPC report from the master node.

25. The first network unit of claim 24, wherein:
the SN change request indicates a threshold for a first timer, and
wherein the SPC report is based on the first PScell change report configuration and a second PScell change report configuration, wherein the second PScell change report configuration indicates a threshold for a second timer associated with a target SN.

26. The first network unit of claim 24, wherein the first network unit is further configured to
receive, from the master node, a secondary cell group (SCG) failure report; and
perform, based on a correlation of the SCG failure report with the SPC report, a network optimization,
wherein the first network unit is configured to receive the SPC report from the master node.

27. The first network unit of claim 26, wherein the first network unit is further configured to:
receive, from the master node, a secondary cell group (SCG) failure report; and
perform, based on a correlation of the SCG failure report with the SPC report, a network optimization,
wherein the first network unit is configured to receive the SPC report from a second master node different from the master node.

28. The first network unit of claim 16, wherein the first network unit is further configured to:
receive a secondary cell group (SCG) failure report, wherein:
the SCG failure report includes a first indicator associated with the SPC report,
the SPC report includes a second indicator associated with the SCG failure report; or
a combination thereof; and
the first network unit is configured to perform a network optimization based on a correlation of the SCG failure report with the SPC report, wherein the correlation is based on at least one of the first indicator or the second indicator.

29. A user equipment (UE) comprises:
a memory device;
a transceiver; and
a processor in communication with the processor and the transceiver, wherein the UE is configured to:
receive, from a network node, a reconfiguration message for a PSCell change;
detect, based on the reconfiguration message, a PSCell change failure;
transmit, to the network node based on the detecting the failure, a secondary cell group (SCG) failure report indicating SCG failure-related information; and
transmit, to the network node after the transmitting the SCG report, a further SCG failure report indicating additional SCG failure-related information.

30. The UE of claim 29, wherein the further SCG failure report comprises at least one of:
an indication of a first satisfied condition associated with the reconfiguration message for PSCell change; or
a time duration between a first satisfied condition and a second satisfied condition associated with the reconfiguration message for PSCell change.
